(19) United States
(12) Patent Application Publication
(10) Pub. No.: US 2004/0003403 A1
(43) Pub. Date: Jan. 1, 2004

(54) Methods and systems for reducing information in electronic program guide and program recommendation systems

(76) Inventor: David J. Marsh, (US)

Correspondence Address: LEE & HAYES PLLC, 421 W RIVERSIDE AVENUE SUITE 500, SPOKANE, WA, 99201

(21) Appl. No.: 10/177,248

(22) Filed: Jun. 19, 2002

(51) Int. Cl. G06F 3/00; H04N 5/445; G06F 13/00

(52) U.S. Cl. 725/53; 725/52; 725/44; 725/46; 725/45

(57) ABSTRACT

In accordance with various embodiments, filter tokens are provided for use in connection with an electronic program guide (EPG) system. Filter tokens can be used to reduce the amount information that is presented to the user in an electronic program guide display. This can help to reduce information overload and can facilitate presenting indicia of programs in which one or more of the users are likely to be interested. Filter tokens can also be used to provide users with a very robust tool to define user preferences of attributes associated with programs that are of interest to the user.

### RELATED APPLICATIONS

This application is related to the following U.S. Patent Applications, the disclosures of which are incorporated by reference herein:

Application Ser. No. 10/125,260, filed Apr. 16, 2002, entitled “Media Content Descriptions” and naming Dave Marsh as inventor;

Application Ser. No. 10/125,259, filed Apr. 16, 2002, entitled “Describing Media Content in Terms of Degrees” and naming Dave Marsh as inventor;

Application Ser. No. ______, bearing Attorney Docket No. ms1-1088, filed May 11, 2002, entitled “Scoring And Recommending Media Content Based On User Preferences”, and naming Dave Marsh as inventor;

Application Ser. No. ______, bearing Attorney Docket No. ms1-1175, filed May 31, 2002, entitled “Entering Programming Preferences While Browsing An Electronic Programming Guide”, and naming Dave Marsh as inventor; and

Application Ser. No. ______, bearing Attorney Docket No. ms1-1186, filed Jun. 6, 2002, entitled “Methods and Systems for Generating Electronic Program Guides”, and naming Dave Marsh as inventor.

Application Ser. No. ______, bearing Attorney Docket No. ms1-1204, filed ______, entitled “Methods and Systems for Enhancing Electronic Program Guides”, and naming Dave Marsh as inventor.

Application Ser. No. ______, bearing Attorney Docket No. ms1-1187, filed ______, entitled “Electronic Program Guides Utilizing Demographic Stereotypes”, and naming Dave Marsh as inventor.

Application Ser. No. ______, bearing Attorney Docket No. ms1-1184, filed ______, entitled “Electronic Program Guide Systems and Methods for Handling Multiple Users”, and naming Dave Marsh as inventor.

### TECHNICAL FIELD

This invention relates to media entertainment systems and, in particular, to systems and methods that are directed to personalizing a user's experience.

### BACKGROUND

Many media entertainment systems provide electronic programming guides (EPGS) that allow users to interactively select programs that they are interested in. Systems that employ EPG technology typically display programs organized according to the channel on which the program will be broadcast and the time at which the broadcast will occur. Information identifying a particular program typically includes the program title, and possibly a short description of the program. In today's world, media entertainment systems can typically offer hundreds of channels from which a user can choose. In the future, many more channels will undoubtedly be offered. This alone can present a daunting task for the user who wishes to locate particular programs of interest. Further complicating the user's experience is the fact that many current electronic programming guides (EPGs) can provide an abundance of information that can take several hours for a user to look through.

Against this backdrop, what many viewers typically end up doing is that they simply review a few favorite channels to see when their favorite programs are playing, and then view those programs at the appropriate times. Additionally, other viewers may simply revert to channel surfing. Needless to say, these outcomes do not provide the user with the best user experience or make effective and efficient use of the user's time.

Accordingly, this invention arose out of concerns associated with providing improved systems and methods that can provide media entertainment users with an efficient, rich, user-specific experience.

### SUMMARY

In accordance with various embodiments described below, filter tokens are provided for use in connection with an electronic program guide (EPG) system. Filter tokens can be used in a couple of different ways. One way to use filter tokens is to reduce the amount information that is presented to the user in an electronic program guide display. This can help to reduce information overload and can facilitate presenting indicia of programs in which one or more of the users are likely to be interested. Another way to use filter tokens is to provide users with a very robust tool to define user preferences of attributes associated with programs that are of interest to the user.

### BRIEF DESCRIPTION OF THE DRAWINGS

FIG. 1 is a block diagram that illustrates program data in accordance with one or more embodiments.

FIG. 2 is a block diagram that illustrates an exemplary environment in which methods, systems, and data structures in accordance with the described embodiments may be implemented.

FIG. 3 is a block diagram that illustrates exemplary components of a content folder in accordance with one embodiment.

FIG. 4 is a flow diagram describing steps in a method in accordance with one embodiment.

FIG. 5 is a high level block diagram that illustrates aspects of but one system that can be utilized to implement one or more embodiments.

FIG. 6 is a block diagram that illustrates exemplary components of a client device in accordance with one embodiment.

FIG. 7 is a block diagram that illustrates a recommendation engine in accordance with one embodiment.

FIG. 8 is a flow diagram describing steps in a method in accordance with one embodiment.

FIG. 9 is an illustration of an exemplary user interface.

FIG. 10 is an illustration of an exemplary user interface that can permit a user to define a filter token in accordance with one embodiment.

FIG. 11 is a more extensive user interface that can permit a user to define a filter token in accordance with one or more embodiments.

FIG. 12 is a flow diagram describing steps in a method in accordance with one embodiment.

FIG. 13 is a block diagram of an exemplary client device that can be utilized to implement one or more embodiments.

### DETAILED DESCRIPTION

Overview

In accordance with the embodiments described below, filter tokens are provided for use in connection with an electronic program guide (EPG) system. Filter tokens can be used in a couple of different ways. One way to use filter tokens is to reduce the amount information that is presented to the user in an electronic program guide display. This can help to reduce information overload and can facilitate presenting indicia of programs in which one or more of the users are likely to be interested. Another way to use filter tokens is to provide users with a very robust tool to define user preferences of attributes associated with programs that are of interest to the user. Such preferences can be stored in a User Preference File, which is described in more detail below.

In accordance with various described embodiments, a filter token can comprise a Boolean combination of program and instance attributes. Program attributes are program-specific attributes that are associated with individual programs. Instance attributes are attributes that are associated with individual instances of the various programs and include such information as when the program is to be broadcast. The program attributes are specified by a content description schema, and the instance attributes are specified by an instance description schema, each of which is discussed in more detail below and in the applications incorporated by reference above.

The discussion below begins with a description of an exemplary system and approach that can be utilized to implement the embodiments that are described further on in this document. It is to be appreciated that the embodiments described herein can be implemented in connection with any suitable EPG system. Hence, the claimed subject matter should not be limited to only those systems that are the same as, or similar to those described below.

Content Description Metadata Collection

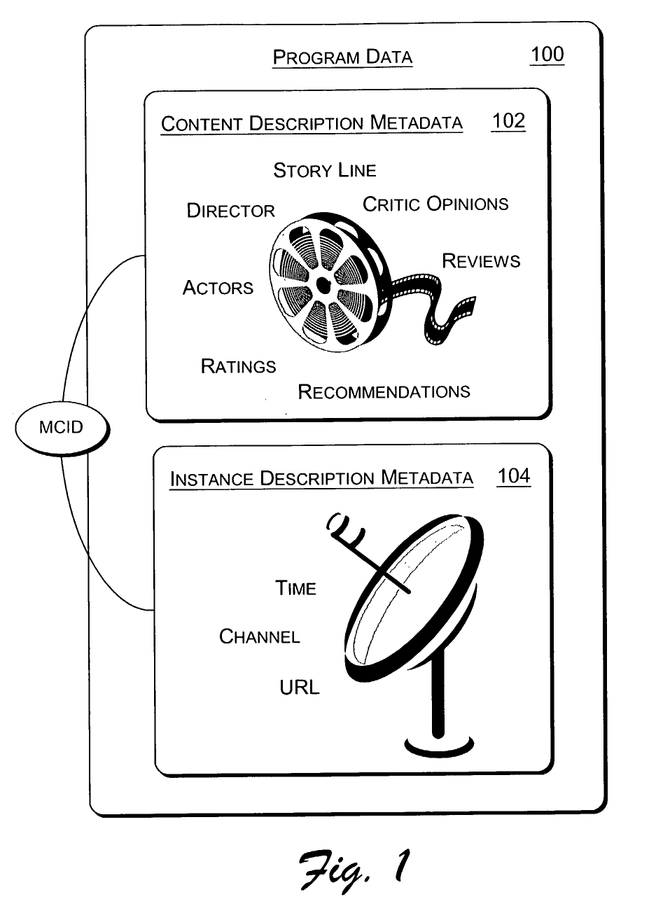

FIG. 1 illustrates two categories of program data 100 that can be associated with various media content (such as movies, television shows and the like) in accordance with the described embodiments. The two types of program data comprise content description metadata 102 and instance description metadata 104.

Content description metadata 102 can comprise a vast number of different types of metadata that pertain to the particular media content. The different types of content description metadata can include, without limitation, the director or producer of the content, actors in a program or movie, story line, ratings, critic opinions, reviews, recommendations, and the like.

Instance description metadata 104 comprises data that pertains to when and where the media content is available. For example, instance description metadata can include the day, time and television channel on which a particular movie or television program will be broadcast. Because content description metadata 102 is associated with the media content itself, and not when a particular instance of the media content is to be broadcast, the content description metadata can be maintained and updated throughout the life of a particular piece of media content. In accordance with the described embodiments, the content description metadata and the instance description metadata are linked via a media content identifier number 106 or “MCID”. An MCID is a unique number that is assigned to the piece of media content to identify it. The MCID can provide a basis by which the particular media content can be easily and readily identified. Once identified, metadata associated with the media content can be easily updated and extended. MCIDs can also be used to generate electronic programming guides for the users and can provide the basis by which a user's likes and dislikes are measured against media content for purposes of recommending to the user those programs that the user would most like to view.

Exemplary Instance Description Metadata

In much the same way that a content description metadata repository can store metadata associated with the media's content, an instance description metadata repository can store metadata associated with instances of various content (such as when the content is to be broadcast and on which channels). An exemplary content description metadata repository is shown and described in U.S. application Ser. No. 10/125,260 incorporated by reference above.

The data repository may be implemented as a relational database, an object-oriented database, a set of one or more data files, one or more XML files based on an XML schema, or any other data structure method. For the purposes of this discussion, an exemplary instance description metadata repository will be described as an XML file.

XML File Details

The XML File Details metadata entity is used to store data associated with the XML file in which the instance description metadata is stored. An example XML File Details entity has the following elements:

Instance Description File Version

Date Time Instance Schedule Created

Instance Schedule Creator Person

Instance Schedule Creator Organization

Language Used For Instance Schedule

Schema Version Used

The Instance Description File Version element stores a number that indicates the version of the file. As data is added to an instance description over time, multiple versions of the file may be stored.

The Date Time Instance Schedule Created element stores the date and time that the file was created.

The Instance Schedule Creator Person element stores the name of the person that created the file.

The Instance Schedule Creator Organization element stores the name of an organization that created the file.

The Language Used For Instance Schedule element stores a value that indicates the language in which the instance description data is provided. In an exemplary system, the value that is stored in the Language Used For Instance Schedule element is a combination of a language code and name according to ISO 639. Examples include “de_German”, “es_Spanish”, and “en_English”. An example list of language field values is given in application Ser. No. 10/125,260.

The Schema Version Used element stores a number that indicates the version of an XML Schema associated with the XML file.

MCIDs

As noted above, the MCID is a number that uniquely identifies the content and provides a way of relating all the various XML metadata files and support files to the content. The MCID appears in every metadata file as it ties everything together. The number structure is: MCID_Series_Episode-Version_Part. The ‘Series’ part of the number is the most significant and is a unique number. For music tracks, the ‘Series’ part of the number is the part that identifies the particular song (i.e. track) and the ‘Episode’ part is not used.

MSI

The MSI or “Metadata Source Identifier” is an identifier that is used to identify the source of the particular metadata. While the use of MSIs has far less relevance to Instance metadata as compared with Content Description metadata, the concept is still useful, for example, for storing different opinions as to the start time of the broadcast.

Each piece of metadata is typically tagged with its source. This allows updates, but also allows stack ranking decisions to be made based on different provider trust levels for each metadata category. Each metadata provider is allocated an MSI. The MSI numbers, and details of the different providers, together with their pecking order for the different metadata categories, are defined in a separate table. In the InstanceSchedule metadata file it is sufficient to just have the numeric source provider numbers (MSIs) against each entered item.

Note that each piece of metadata (e.g. the time) is typically tagged with the identifier (MSI) of that provider. If at a later date an entry for that metadata category (e.g. the time) is suggested by a different provider, then the tagging allows the system to know whether that suggested entry has a higher pecking order trust rating than the piece of metadata from the current entry provider.

As well as each piece of metadata being tagged with the identifier of the provider, each entry can also have a date/time stamp. This is the DateTime attribute.

CID

Each TV channel is given a Channel Identifier or “CID”. This CID is the same if the same channel is broadcast on say Satellite and Cable. The details of each channel are given in a separate schema.

Exemplary Instance Description Metadata Categories

Instance description metadata can include many types of data, including language data, preference data, and various data associated with an instance schedule.

Exemplary language data is described in U.S. patent application Ser. No. 10/125,260, incorporated by reference above. Accordingly, for the sake of brevity, it is not discussed further herein.

Preference Data

Preference data specifies the significance of a metadata category with which it is associated. The preference data can typically be used in a user's preference file, examples of which are provided below. In this example, the preference data can be provided as a significance value having the following values: +5, +4, +3, +2, +1, 0, −1, −2, −3, −4, −5, “NV_Never-View”, “RA_Record_Always”, “WL_Watch_Live”, and “FT-Filter_Token”.

Instance Schedule Data

In the illustrated and described embodiment, the root of the instance schedule data is a “Instance Schedule” element. Within the Instance Schedule element are the following sub-elements:

XMLFileDetails element—which is associated with data that describes details of the XML file; and

ContentItem element—which is associated with data that pertains to the particular instances of various content.

ContentItem Element

The ContentItem Element includes the following sub-elements, each of which is further expanded upon in its own designated section below:

ChannelInstance

WebInstance

LocalInstance

BroadcastFreshness

BroadcastTermination

TransmissionCompression

TransmissionFormat

RecordingRestrictions

ViewingRestrictions

PriceToWatch

PayProgramOfferExpirationDateTime

PayProgramOfferPlayCount

PayProgramTimeActivatedDateTime

PayProgramRightsExpirationDateTime

Ownership

Status

BookmarkContentStart

InstanceNote

DescriptionModifications

The Channellnstance element has the following associated attributes, set out in their XML format:

<xsd:complexType name=“Channel Instance”>

<xsd:attribute name=“CID”type=“CID”/>
<xsd:attribute name=“BroadcastChannel”type=
“xsd:positiveInteger”/>
<xsd:attribute name=“DeliveryMethod”type=
“DeliveryMethod Enum”/>
<xsd:attribute name=“StartTime”type=“xsd:time”/>
<xsd: attribute name=“AllocatedDuration”type=“xsd:time”/>
<xsd:attribute name=“MSI”type=“MSI”/>
<xsd:attribute name=“DateTime”type=“xsd:dateTime”/>
<xsd:attribute name=“XPref”type=“XPrefEnum”/>
<xsd:attribute name=“XSignif”type”xsd:positiveInteger”/>

</xsd:complextype>
<xsd.simpleType name=“DeliveryMethodEnum”>

<xsd:restriction base=“xsd:string”>

<xsd:enumeration value=“Unknown”/>
<xsd:enumeration value=“None”/>
<xsd:enumeration value=“Terrestrial”/>
<xsd:enumeration value=“Cable_Analog”/>
<xsd:enumeration value=“Cable_Digital”/>
<xsd:enumeration value=“Satellite_DirecTV”/>
<xsd:enumeration value=“Satellite_Echostar”/>
<xsd:enumeration value=“IP_Delivery”/>
<xsd:enumeration value=“Other”/>

</xsd:restriction>

</xsd:simpleType>

The WebInstance element has the following associated attributes, set out in their XML format:

<xsd:complexType name=“WebInstance”>

<xsd:attribute name=“Value”type=“xsd:string”/>
<xsd:attribute name=“MSI”type=“MSI”/>
<xsd:attribute name=“DateTime”type=“xsd:dateTime”/>
<xsd:attribute name=“XPref”type=“XPrefEnum”/>
<xsd:attribute name=“XSignif”type=“xsd:positiveInteger”/>

<xsd:complexType>

The LocalInstance element has the following associated attributes, set out in their XML format:

<xsd.complexType name=“LocalInstance”>

<xsd:attribute name=“Value”type=“xsd:string”/>
<xsd:attribute name=“MSI”type=“MSI”/>
<xsd:attribute name=“DateTime”type=“xsd:dateTime”/>
<xsd:attribute name=“XPref”type=“XPrefEnum”/>
<xsd:attribute name=“XSignif”type=“xsd:positiveInteger”/>

</xsdcomplexType>

The BroadcastFreshness element has the following associated attributes, set out in their XML format:

<xsd:complexType name=“BroadcastFreshness”>

<xsd:attribute name=“Value”type=“BroadcastFreshnessEnum”/>
<xsd:attribute name=“MSI”type=“MSI”/>
<xsd:attribute name=DateTime type=“xsd:dateTime”/>
<xsd:attribute name=“XPref”type=“XPrefEnum”/>
<xsd:attribute name=“XSignif”type=“xsd:positiveInteger”/>

</xsd:complexType>
<xsd:simpleType name=“BroadcastFreshnessEnum”>

<xsd restriction base=“xsd:string”>

<xsd:enumeration value=“Unknown”/>
<xsd:enumeration value=“None”/>
<xsd:cnumeration value=“Live”/>
<xsd:enumeration value=“Live_With_TimeZone_delay”/>
<xsd:enumeration value=
“First_Showing_(On_This_Channel)”/>
<xsd:enumeration value=“Last_Showing_(On_This_Channel)”/>
<xsd:enumeration value=“Repeat_(On_This_Channel)”/>
<xsd:enumeration value=“Other”/>

</xsd:restriction>

</xsd:simpleType>

The BroadcastTermination element has the following associated attributes, set out in their XML format:

<xsd:complexType name=“BroadcastTermination”>

<xsd:attribute name=“LeaveInProgress”type=“BooleanEnum”/>
<xsd:attribute name=“Comment”type=“xsd:string”/>
<xsd:attribute name=“MSI”type=“MSI”/>
<xsd:attribute name=“DateTime type=“xsd:dateTime”/>
<xsd:attribute name=“Language”type=“LanguageEnum”/>
<xsd:attribute name=“XPref”type=XPrefEnum”/>
<xsd:attribute name=“XSignif”type=“xsd:positiveInteger”/>

</xsd:complexType>

The “LeaveInProgress” attribute can be used for such things as the following: assume that a World Cup soccer match is broadcast and the TV broadcaster has made the decision to extend the program if the match goes into extra time. This attribute covers this type of scenario.

The “Comment” field allows for broadcasters to add some text to justify their decision (particularly as some people get annoyed if broadcasters adjust the schedule at the last minute, thereby desynchronizing auto recordings).

The TransmissionCompression element has the following associated attributes, set out in their XML format:

<xsd:complexType name=“TransmissionCompression”>

<xsd:attribute name=
“CompressionType”type=“CompressionTypeEnum”/>
<xsd:attribute name=“BitrateKbps”type=“xsd:positiveInteger”/>
<xsd:attribute name=“MSI”type=“MSI”/>
<xsd:attribute name=“DateTime”type=“xsd:dateTime”/>
<xsd:attribute name=“XPref”type=“XPrefEnum”/>
<xsd:attribute name=“XSignif”type=“xsd:positiveInteger”/>

</xsd:complexType>
<xsd:simpleType name=“CompressionTypeEnum”>

<xsd:restriction base=“xsd:string”>

<xsd:enumeratton value=“Unknown”/>
<xsd:enumeration value=“None”/>
<xsd:enumeration value=“JPEG”/>
<xsd:enumeration value=“JPEG2000”/>
<xsd:enumeration value=“DV”/>
<xsd:enumeration value=“MPEG1”/>
<xsd:cnumeration value=“MPEG2”/>
<xsd.enumeration value=“MPEG4”/>
<xsd:enumeration value=“WindowsMedia”/>
<xsd:enumeration value=“Real”/>
<xsd:enumeration value=“Other”/>

</xsd.restriction>

</xsd:simpleType>

The TransmissionFormat element has the following associated attributes, set out in their XML format:

<xsd:complexType name=TransmissionFormat”>

<xsd:attribute name=“Horizontal”type=“xsd:positiveInteger”/>
<xsd:attribute name=“Vertical type=“xsd:positiveInteger”/>
<xsd:attribute name=“TemporalRateHz”type=“xsd:double”/>
<xsd:attribute name=“Interlaced”type=“BooleanEnum”/>
<xsd:attribute name=“MSI”type=“MSI”/>
<xsd:attribute name=“DateTime”type=“xsd:dateTime”/>
<xsd:attribute name=“XPref”type=“XPrefEnum”/>
<xsd:attribute name=“XSignif”type=“xsd:positiveInteger”/>

</xsd:complexType>

The RecordingRestrictions element has the following associated attributes, set out in their XML format:

<xsd:complexType name=“RecordingRestrictions”>

<xsd:attribute name=“Value”type=“RecordingRestrictionsEnum”/>
<xsd:attribute name=“MSI”type=“MSI”/>
<xsd:attribute name=“DateTime”type=“xsd:dateTime”/>
<xsd:attribute name=“XPref”type=“XPrefEnum”/>
<xsd:attribute name=“XSignif”type=“xsd:positiveInteger”/>

<xsd:complexType>
<xsd:simpleType name=“RecordingRestrictionsEnum”>

<xsd:restriction base=xsd:string”>

<xsd:enumeration value=“Unknown”/>
<xsd:enumeration value=“None”/>
<xsd:enumeration value=“Copy_Never”/>
<xsd:enumeration value=“Copy_Once”/>
<xsd:enumeration value=“Copy_Twice”/>
<xsd:enumeration value=“Copy_Three_Times”/>
<xsd:enumeration value=“Copy_Five_Times”/>
<xsd:enumeration value=“Copy_Ten_Times”/>
<xsd:enumeration value=“Other”/>

</xsd:restriction>

</xsd:simpleType>

The ViewingRestrictions element has the following associated attributes, set out in their XML format:

<xsd:complexType name=“ViewingRestrictions”>

<xsd:attribute name=“Value”type=“ViewingRestrictionsEnum”/>
<xsd:attribute name=“MSI”type”=“MSI”/>
<xsd:attribute name=“DateTime”type=“xsd:dateTime”/>
<xsd:attribute name=“XPref”type=“XPrefEnum”/>
<xsd:attribute name=“XSignif”type=“xsd:positiveInteger”/>

</xsd:complexType>
<xsd:simpleType name=“ViewingRestrictionsEnum”>

<xsd:restriction base=“xsd:string”>

<xsd:enumeration value=“Unknown”/>
<xsd:enumeration value=“None”/>
<xsd.enumeration value=“Trick_Play_Not_Allowed”/>
<xsd:enumeration value=
“Pausing_Or_Trick_Play_Not_Allowed”/>
<xsd:enumeration value=
“Not_Viewable_On_Secondary_TVs_in_House”/>
<xsd:enumeration value=“Other”/>

</xsd:restriction>

</xsd:simpleType>

The “Trick_Play_Not_Allowed” field is a feature that provides a mechanism for restricting what the user is able to do with the content.

The PriceToWatch element has the following associated attributes, set out in their XML format:

<xsd:complexType name=“PriceToWatch”>

<xsd:attribute name=“Price”type=“xsd:string”/>
<xsd:attribute name=“Currency”type=“xsd:string”/>
<xsd:attribute name=“MSI”type=“MSI”/>
<xsd:attribute name=“DateTime”type=“xsd:dateTime”/>
<xsd:attribute name=“XPref”type=“XPrefEnum”/>
<xsd:attribute name=“XSignif”type=“xsd:positiveInteger”/>

</xsd:complexType>

The PayProgramOfferExpirationDateTime element has the following associated attributes, set out in their XML format:

<xsd:complexType name=“PayProgramOfferExpirationDateTime”>

<xsd:attribute name=“Value”type=“xsd:dateTime”/>
<xsd:attribute name=“MSI”type=“MSI”/>
<xsd:attr,bute name=“DateTime”type=“xsd.dateTime”/>
<xsd:attribute name=“XPrcf”type=“XPrefEnum”/>
<xsd:attribute name=“XSignif”type=“xsd:positveInteger”/>

</xsd:complexType>

The PayProgramOfferPlayCount element has the following associated attributes, set out in their XML format:

<xsd:complexType name=“PayProgramOfferPlayCount”>

<xsd:attribute name=“Value type=“xsd:positiveInteger”/>
<xsd:attribute name=“MSI”type=“MSI”/>
<xsd:attribute name=“DateTime”type=“xsd:dateTime”/>
<xsd:attribute name=“XPref type=“XPrefEnum”/>
<xsd:attribute name=“XSignif”type=”xsd:positiveInteger”/>

</xsd:complexType>

The “PayProgramOfferPlayCount” provides a mechanism for providers to specify how many times a viewer is able to play the content after they purchase it from a video on demand offer.

The PayProgramTimeActivatedDateTime element has the following associated attributes, set out in their XML format:

<xsd:complexType name=“PayProgramTimeActivatedDateTime”>

<xsd:attribute name=“Value”type=“xsd:dateTime”/>
<xsd:attribute name=“MSI”type=“MSI”/>
<xsd:attribute name=“DateTime”type=“xsd:dateTime”/>
<xsd:attribute name=“XPref”type=“XPrefEnum”/>
<xsd:attribute name=“XSignif”type=“xsd:positiveInteger”/>

</xsd:complexType>

The “PayProgramTimeActivatedDateTime” element specifies when the video on demand purchase that a consumer has made becomes active, e.g. the user may purchase the 8 pm viewing of the movie.

The PayProgramRightsExpirationDateTime element has the following associated attributes, set out in their XML format:

<xsd:complexType name=“PayProgramRightsExpirationDateTime”>

<xsd:attribute name=“Value”type=“xsd:dateTime”/>
<xsd:attribute name=“MSI”type=“MSI”/>
<xsd:attribute name=“DateTime”type=“xsd:dateTime”/>
<xsd:attribute name=“XPref”type==“XPrefEnum”/>
<xsd:attribute name=“XSignif”type=“xsd.positiveInteger”/>

</xsd:complexType>

The “PayProgramRightsExpirationDateTime” element is a video on demand feature. The user may purchase the right to view the movie for a period of say 24 hours. They can watch it as many times as they like up until the expiration time.

The Ownership element has the following associated attributes, set out in their XML format:

<xsd:complexType name=“Ownership”>

<xsd:attribute name=“Value”type=“OwnershipEnum”/>
<xsd:attribute name=“MSI”type=“MSI”/>
<xsd:attribute name=“DateTime”type=“xsd.dateTime”/>
<xsd:attribute name=“XPref”type=“XPrefEnum”/>
<xsd:attribute name=“XSignif”type=“xsd:positiveInteger”/>

</xsd:complexType>
<xsd:simpleType name=“OwnershipEnum”>

<xsd:restriction base=“xsd:string>

<xsd:enumeration value=“Unknown”/>
<xsd:enumeration value=“None”/>
<xsd:enumeration value=“OnLine_Access_Owned”/>
<xsd.enumeration value=“File_Owned”/>
<xsd:enumeration value=“DVD_Owned”/>
<xsd:enumeration value=“Other”/>

</xsd:restriction>

</xsd:simpleType>

This element is used to specify what rights the viewer has purchased. For example, the viewer may have only purchased the rights to view it at the broadcast time, or they may have paid to download the file for unrestricted viewing, or they may have purchased the DVD to add to their shelf library

The Status element has the following associated attributes, set out in their XML format:

<xsd:complexType name=“Status”>

<xsd:attribute name=“Value”type=“StatusEnum”/>
<xsd:attribute name=“MSI”type=“MSI”/>
<xsd:attribute name=“DateTime”type=“xsd:dateTime”/>
<xsd:attribute name=“XPref”type=“”XPrefEnum”/>
<xsd:attribute name=“XSignif”type=“xsd:positiveInteger”/>

</xsd:complexType>
<xsd:simpleType name=“StatusEnum”>

<xsd:restriction base=“xsd:string”>

<xsd:enumeration value=“Unknown”/>
<xsd:enumeration value=“None”/>
<xsd:enumeration value=“Waiting_To_Be_Recorded”/>
<xsd:enumeration value=“Reminder_Set”/>
<xsd:enumeration value=“DVD_In_Jukebox”/>
<xsd:enumeration value=“Other”/>

</xsd.restriction>

</xsd:simpleType>

The BookmarkContentStart element has the following associated attributes, set out in their XML format:

<xsd:complexType name=“BookmarkContentStart”>

<xsd:attribute name=“Value”type=“xsd:string”/>
<xsd:attribute name=“MSI”type=“MSI”/>
<xsd:attribute name=“DateTime”type=“xsd:dateTime”/>
<xsd:attribute name=“XPref”type=“XPrefEnum”/>
<xsd:attribute name=“XSignif”type=“xsd:positiveInteger”/>

</xsd:complexType>

This element allows a bookmark to be set to the actual beginning of the content. It is useful to avoid all the promotional trailers that are starting to typically precede the actual movie.

The InstanceNote element has the following associated attributes, set out in their XML format:

<xsd:complexType name=“InstanceNote”>

<xsd:attribute name=“Value”type=“xsd:string”/>
<xsd:attribute name=“MSI”type=“MSI”/>
<xsd:attribute name=“DateTime”type=“xsd:dateTime”/>
<xsd:attribute name=“XPref”type=“XPrefEnum”/>
<xsd:attribute name=“XSignif”type=“xsd:positiveInteger”/>

</xsd:complexType>

This element is a catch all mechanism for any assorted additional comments about the particular instance.

The DescriptionModifications element comprises any of the attributes included in the Content Description schema. Suppose, for example, a program is made with stereo sound. If a particular TV station decided to broadcast it with only mono sound, then the content description attribute of “mono” would be included in the instance description and overrides what is in the content description.

Exemplary Instance Schedule File

The following constitutes an exemplary Instance Schedule File that utilizes the above-described schema:

<?xml version=“1.0”encoding=“utf-8”?>
<InstanceSchedule xmlns=“http://tempuri.org/
InstanceScheduleSchema.xsd”ScheduleDayDate=“2001-07-01”>
<XMLFileDetails InstanceScheduleFileVersion=
“1.0”DateTimeInstanceScheduleCreated=“2001-07-
01T20:00:00.0000000-0700”
InstanceScheduleCreatorPerson=“Dave Marsh”
InstanceScheduleCreatorOrganization=
“Microsoft”LanguageUsedForInstanceSchedule=“en_English”
SchemaVersionUsed=“1.0”/>
<ContentItem MCID=
“MCID_0001-0000-0000-000e_0000_X_0000-0000_X_00”>
<ChannelInstance CID=“CID_0001_002a”
BroadcastChannel=“567”DeliveryMethod=“Satellite_DirecTV”
StartTime=“19-30-00”AllocatedDuration=“00-30-00”/>
<BroadcastFreshness Value=“Repeat(On_This_Channel)”/>
<BroadcastTermination LeaveInProgress=
“false”Comment=“No comment”/>
<TransmissionCompression CompressionType=
“MPEG2”BitrateKbps=“6000”/>
<TransmissionFormat Horizontal=
“640”Vertical=“480”TemporalRateHz=“59.94”Interlaced=“true”/>
<RecordingRestrictions Value=“Copy_Three_Times”/>
<ViewingRestrictions Value=“Trick_Play_Not_Allowed”/>
<PriceToWatch Price=“4”Currency=“US Dollars”/>
<PayProgramOfferExpirationDateTime Value=“2001-11-14T18-00-00”/>
<PayProgramOfferPlayCount Value=“3”/>
<PayProgramTimeActivatedDateTime Value=“2001-10-14T18-00-00”/>
<PayProgramRightsExpirationDateTime Value=
“2001-12-14T18-00-00”/>
<Ownership Value=“DVD_Owned”/>
<Status Value=“Waiting_To_Be_Recorded”/>
<BookmarkContentStart Value=“ABCD 1234 XYZA 5678”/>
<InstanceNote Value=“A note about this instance.”/>
</ContentItem>
<Content Item MCID=
“MCID_0001-0000-0000-
023e_0000_X_0000-0000_X_00”>
<ChannelInstance CID=“CID_0001_002a”
BroadcastChannel=“567”DeliveryMethod=“Satellite_DirecTV”
StartTime=“20-00-00”AllocatedDuration=“01-30-00”/>
</ContentItem>
<ContentItem MCID=“MCID_0001-0000-0000-
0456_0000_X_0000-0000_X_00”>
<ChannelInstance CID=“CID_0001_002a”
BroadcastChannel=“567”DeliveryMethod=“Satellite_DirecTV”
StartTime=“21-30-00”AllocatedDuration=“00-30-00”/>
</ContentItem>
<ContentItem MCID=“MCID_0001-0000-0000-
0876_0000_X_0000-0000_X_00”>
<ChannelInstance CID=“CID_0001_002a”
BroadcastChannel=“567”DeliveryMethod=“Satellite_DirecTV”
StartTime=“22-00-00”AllocatedDuration=“00-30-00”/>
</ContentItem>
<ContentItem MCID=“MCID_0001-0000-0000-
0a75_0000_X_0000-0000_X_00”>
<ChannelInstance CID=“CID_0001_002b”
BroadcastChannel=“568”DeliveryMethod=“Satellite_DirecTV”
StartTime=“20-00-00”AllocatedDuration=“00-30-00”/>
</ContentItem>
<InstanceSchedule>

Exemplary Environment

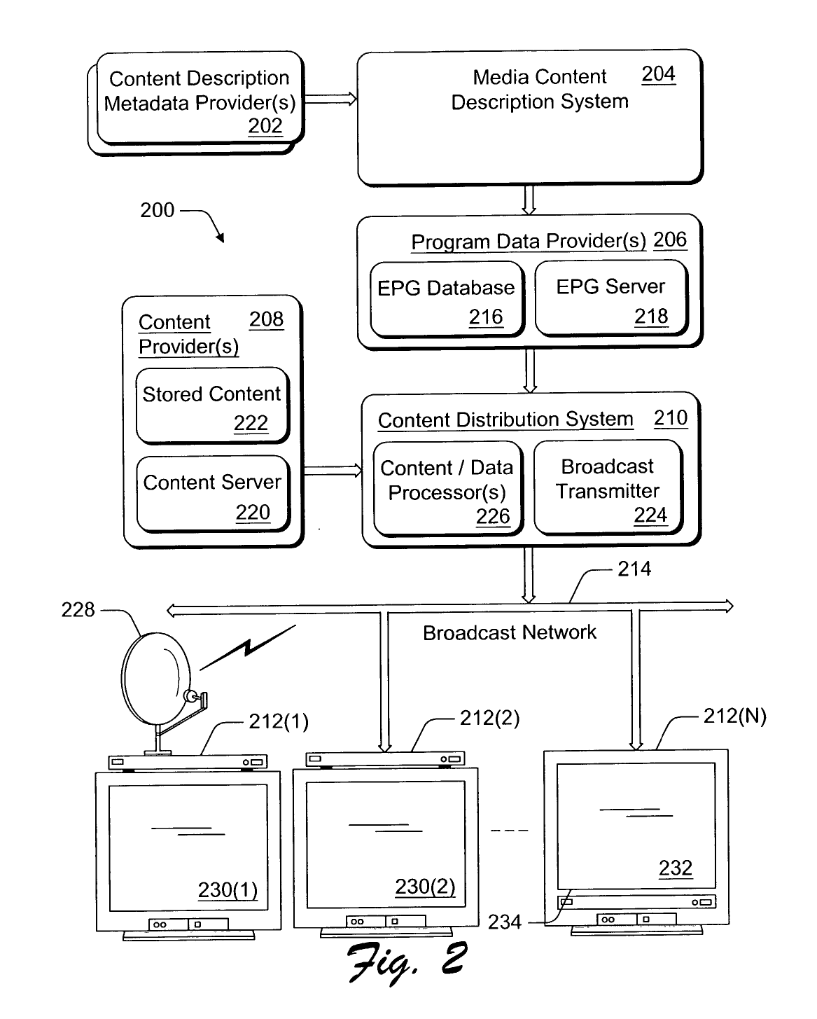

FIG. 2 illustrates an exemplary environment 200 in which the methods, systems, and data structures described herein may be implemented. The environment is a media entertainment system that facilitates distribution of media content and metadata associated with the media content to multiple users. Environment 200 includes one or more content description metadata providers 202, a media content description system 204, one or more program data providers 206, one or more content providers 208, a content distribution system 210, and multiple client devices 212(1), 212(2), . . . , 212(N) coupled to the content distribution system 210 via a broadcast network 214.

Content description metadata provider 202 provides content description metadata associated with media content to media content description system 204. Example content description metadata providers can include, without limitation, movie production companies, movie distribution companies, movie critics, television production companies, program distributors, music production companies, and the like. Essentially, any person, company, system, or entity that is able to generate or supply media content description metadata can be considered a content description metadata provider 202.

Media content description system 204 stores media content description metadata associated with a plurality of metadata categories and stores metadata received from one or more metadata providers 202. In one implementation, the media content description system 204 generates composite metadata based on metadata received from a plurality of metadata providers 202. Media content description system 204 provides the media content description metadata to program data provider 206. Typically, such metadata is associated with many different pieces of media content (e.g., movies or television programs).

Program data provider 206 can include an electronic program guide (EPG) database 216 and an EPG server 218. The EPG database 216 stores electronic files of program data which can be used to generate an electronic program guide (or, “program guide”). The program data stored by the EPG database, also termed “EPG data”, can include content description metadata 102 and instance description metadata 104. For example, the EPG database 216 can store program titles, ratings, characters, descriptions, actor names, station identifiers, channel identifiers, schedule information, and the like.

The EPG server 218 processes the EPG data prior to distribution to generate a published version of the EPG data which contains programming information for all channels for one or more days. The processing may involve any number of techniques to reduce, modify, or enhance the EPG data. Such processes can include selection of content, content compression, format modification, and the like. The EPG server 218 controls distribution of the published version of the EPG data from program data provider 206 to the content distribution system 210 using, for example, a file transfer protocol (FTP) over a TCP/IP network (e.g., Internet, UNIX, etc.). Any suitable protocols or techniques can be used to distribute the EPG data.

Content provider 208 includes a content server 220 and stored content 222, such as movies, television programs, commercials, music, and similar media content. Content server 220 controls distribution of the stored content 222 from content provider 208 to the content distribution system 210. Additionally, content server 220 controls distribution of live media content (e.g., content that is not previously stored, such as live feeds) and/or media content stored at other locations.

Content distribution system 210 contains a broadcast transmitter 224 and one or more content and program data processors 226. Broadcast transmitter 224 broadcasts signals, such as cable television signals, across broadcast network 214. Broadcast network 214 can include a cable television network, RF, microwave, satellite, and/or data network, such as the Internet, and may also include wired or wireless media using any broadcast format or broadcast protocol. Additionally, broadcast network 214 can be any type of network, using any type of network topology and any network communication protocol, and can be represented or otherwise implemented as a combination of two or more networks.

Content and program data processor 226 processes the media content and EPG data received from content provider 208 and program data provider 206 prior to. transmitting the media content and EPG data across broadcast network 214. A particular content processor may encode, or otherwise process, the received content into a format that is understood by the multiple client devices 212(1), 212(2), . . . , 212(N) coupled to broadcast network 214. Although FIG. 2 shows a single program data provider 206, a single content provider 208, and a single content distribution system 210, environment 200 can include any number of program data providers and content providers coupled to any number of content distribution systems.

Content distribution system 210 is representative of a head end service that provides EPG data, as well as media content, to multiple subscribers. Each content distribution system 210 may receive a slightly different version of the EPG data that takes into account different programming preferences and lineups. The EPG server 218 creates different versions of EPG data (e.g., different versions of a program guide) that include those channels of relevance to respective head end services. Content distribution system 210 transmits the EPG data to the multiple client devices 212(1), 212(2), . . . , 212(N). In one implementation, for example, distribution system 210 utilizes a carousel file system to repeatedly broadcast the EPG data over an out-of-band channel to the client devices 212.

Client devices 212 can be implemented in multiple ways. For example, client device 212(1) receives broadcast content from a satellite-based transmitter via a satellite dish 228. Client device 212(1) is also referred to as a set-top box or a satellite receiving device. Client device 212(1) is coupled to a television 230(1) for presenting the content received by the client device, such as audio data and video data, as well as a graphical user interface. A particular client device 212 can be coupled to any number of televisions 230 and/or similar devices that can be implemented to display or otherwise render content. Similarly, any number of client devices 212 can be coupled to a television 230.

Client device 212(2) is also coupled to receive broadcast content from broadcast network 214 and communicate the received content to associated television 230(2). Client device 212(N) is an example of a combination television 232 and integrated set-top box 234. In this example, the various components and functionality of the set-top box are incorporated into the television, rather than using two separate devices. The set-top box incorporated into the television may receive broadcast signals via a satellite dish (similar to satellite dish 228) and/or via broadcast network 214. A personal computer may also be a client device 212 capable of receiving and rendering EPG data and/or media content. In alternate implementations, client devices 212 may receive broadcast signals via the Internet or any other broadcast medium.

Each client 212 runs an electronic program guide (EPG) application that utilizes the EPG data. An EPG application enables a TV viewer to navigate through an onscreen program guide and locate television shows of interest to the viewer. With an EPG application, the TV viewer can look at schedules of current and future programming, set reminders for upcoming programs, and/or enter instructions to record one or more television shows.

Content Folders

In accordance with the embodiments described below, the notion of a content folder is employed and utilized to hold metadata that pertains to media content that can be experienced by a user. The content folder can be utilized to hold or otherwise aggregate many different types of metadata that can be associated with the media content-including the media content itself. The metadata that is provided into a content folder can come from many different metadata providers and can be provided at any time during the life of the media content.

As an example, consider the following. When media content is first created, content description metadata can be provided for the particular media content. Such content description metadata can include such things as the name of the content (such as movie or program name), actors appearing in the movie or program, year of creation, director or producer name, story line description, content rating and the like.

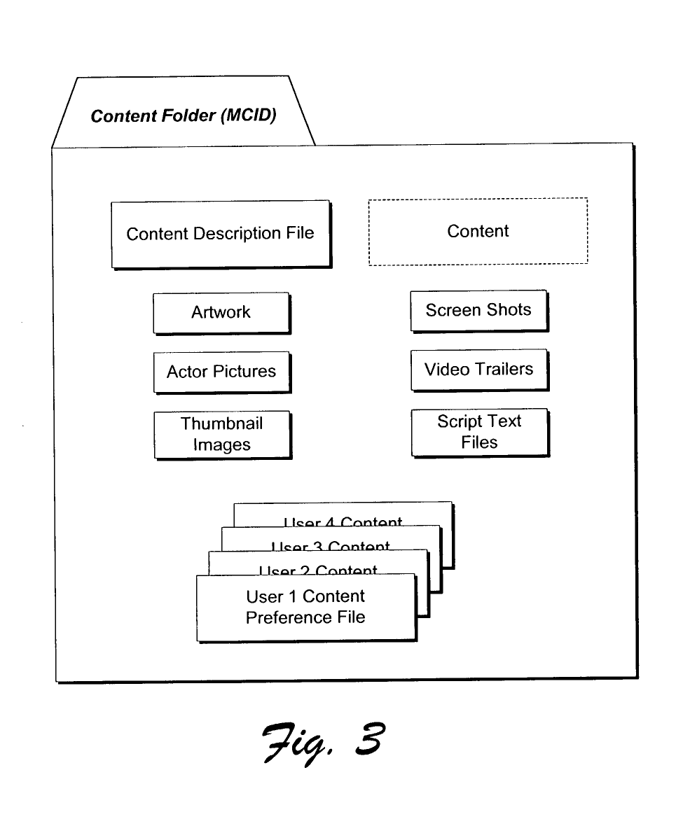

As an example, consider FIG. 3 which shows an exemplary content folder. The content folder is associated with a particular piece of content and, hence, is associated with an MCID that identifies the content. Within the content folder, many different types of metadata can be collected. For example, the content folder can include, without limitation, a content description file that describes the content (an example of which is provided below), and files associated with any artwork that might be associated with the content, actor pictures, thumbnail images, screen shots, video trailers, and script text files, to name just a few. The content folder can also contain the actual content itself, such as a digitally encoded program or movie. The content folder can, in some embodiments, contain one or more user content preference files which are described in more detail in the section entitled “User Content Preference File” below.

Over time, more content description metadata may become available and can be added to the content folder. For example, after a movie is released, critic opinions, and recommendations may become available. Because this is information related to the media content itself (and not just a particular broadcast or showing of the media content), this information can be added to the content folder. At a still later point in time, additional reviews of the media content may become available and can thus be added to the content folder. Additional metadata that can be incorporated into the content folder can include such things as special promotional data associated with the content, data from fan sites, and many more different types of metadata.

Content description metadata can typically be generated by many different sources (e.g., movie production companies, movie critics, television production companies, individual viewers, etc.). A media content description system (such as system 204 in FIG. 2) can store content description metadata from the multiple sources, and can make the content description metadata available to users via one or more servers or other content distribution systems.

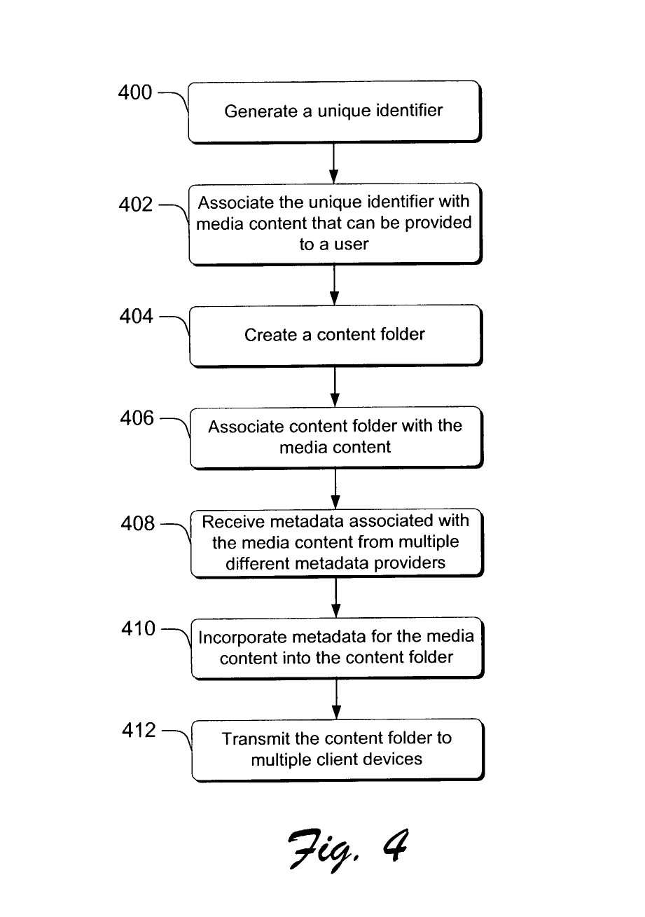

FIG. 4 is a flow diagram that describes steps in a metadata collection method in accordance with one embodiment. The steps can be implemented in any suitable hardware, software, firmware or combination thereof. In the illustrated example, the steps can be implemented in connection with a metadata collection and transmission system. Exemplary components that can perform the functions about to be described are shown and described in connection with FIG. 2.

Step 400 generates a unique identifier and step 402 associates the unique identifier with media content that can be provided to a user. An example of such a unique identifier is described above in connection with the MCID. The media content with which the unique identifier can be associated is a specific piece of media content, such as a specific movie or television program. In practice, these steps are implemented by one or more servers or other entities in connection with a vast amount of media content. The servers or entities serve as a collection point for metadata that is to be associated with the particular media content. Step 404 creates a content folder and step 406 associates the content folder with the particular media content. These steps can also be performed by the server(s) or entities. The intent of these steps is to establish a content folder for each particular piece of media content of interest.

Step 408 receives metadata associated with the media content from multiple different metadata providers. These metadata providers need not and typically are not associated or affiliated with one another. Step 410 then incorporates the metadata that is received from the various metadata providers into the content folder that is associated with the particular media content. As noted above, this process is an ongoing process that can extend during the entire life of the particular piece of media content. The result of this step is that, over time, a very rich and robust collection of metadata is built up for each piece of media content of interest. Software executing on the server can use aggregation techniques to ascertain the best value for each program attribute using the entries from the different metadata providers. For example, different opinions as to the value of attributes can be collected from the different metadata providers. The “best” value, i.e. the one that gets sent to the client, is built by the server software using various techniques depending on the attribute type. For example, sometimes the best value is the value from the most trustworthy metadata provider. Yet other times, a vote can be taken as to the best value. Still further, for example in the case of “Degrees Of” attributes, percentages can be calculated by looking at all of the opinions from the metadata providers. Data aggregation techniques are described in some of the applications incorporated by reference above. An example of a content folder is shown and described in FIG. 3.

Step 412 transmits the content folder to multiple different client devices. This step can be implemented by transmitting all of the constituent files of the content folder, or by transmitting a pared down version of the content folder-depending on the needs and capabilities of the particular client devices to which transmission occurs.

The content folders can be used in different ways. For example, the content folder can be used in an EPG scenario to enable the EPG software on the client device to generate and render an EPG for the user. The content folder can also be used by end users to hold not only the metadata for the media content, but the media content as well.

Using Content Folders to Generate EPGs

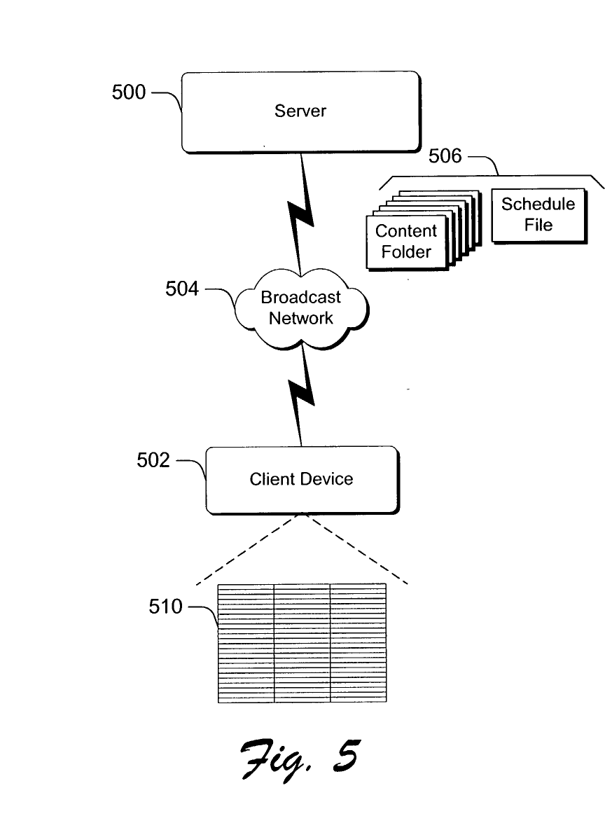

FIG. 5 is a block diagram that can be used to understand how the client device can use the various content folders to generate an EPG. In this example, a server 500 builds and maintains many different content folders, such as the content folders that are described above. In addition, the server can build a schedule file. The content folders and schedule files are shown collectively at 506.

The schedule file is a description of the programs that are to be broadcast over a future time period for which an EPG is going to be constructed. For example, the schedule file can describe which programs are going to be broadcast for the next two weeks. Thus, the schedule file contains the instance description metadata as described in FIG. 1. The schedule file can be implemented as any suitable type of file. In this particular example, the schedule file is implemented as an XML file. The schedule file refers to the pieces of media content (i.e. programs) by way of their respective unique identifiers or MCIDs. Thus, the schedule file contains a list of MCIDs, the times when, and the channels on which the associated programs are going to be broadcast.

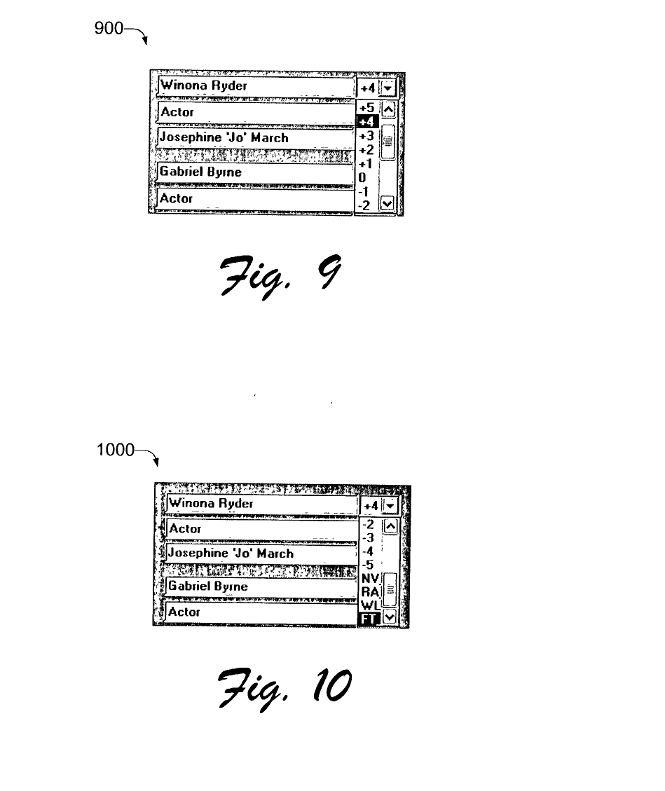

The schedule file and content folders that correspond to the MCIDs in the schedule file are transmitted, via a suitable broadcast network 504, to multiple client devices such as client device 502. The client device can now use the schedule file and the various content folders to construct an EPG grid, such as EPG 510, for the user. A specific example of an EPG such as one that can be generated in accordance with the embodiments described herein is shown in FIG. 9.

Specifically, when the client device receives the schedule file, an EPG application executing on the client device can read the schedule file and ascertain the MCIDs that correspond to the programs that are going to be broadcast. The EPG application can then construct a suitable grid having individual cells that are to contain representations of the programs that are going to be broadcast. Each cell typically corresponds to a different MCID. To populate the grid, the EPG application can access the appropriate the content folders, by virtue of the MCIDs that are associated with the content folders, and render the metadata contained in the content folder in the appropriate cell for the MCID of interest. The EPG application can also provide any user interface (UI) components that are desirable to access additional metadata that is not necessarily displayed—such as a movie trailer, a hyperlink and the like.

In one embodiment, an optimization can be employed to ensure that client devices are provided metadata within the content folder that they can use. Thus, metadata that is not necessarily useful for the client device can be excluded from the content folder that is transmitted to the client device. For example, if the client device does not have a position in its user interface to display a particular piece of information, or if the client device lacks the necessary resources to meaningfully use the metadata (e.g. the client lacks the capabilities to display a video trailer), then such metadata should not be transmitted to the client device when the content folders are transmitted. One way of implementing such an optimization is as follows. Prior to downloading the content folders, server 500 and client device 502 communicate with one another by, for example, a SOAP protocol, and the client device identifies for the server which information or metadata it is interested in. This can assist the server in assigning a class designation to the client device (e.g. thick client, thin client and/or varying degrees therebetween) so that the appropriate metadata is sent to the client.

The content folders can be used by the client device in a couple of different ways depending on the configuration and capabilities of the client device. For clients that are “thick” and support a database querying engine (such as a SQL engine), complex querying can be utilized locally on the client. In this case, certain files (such as the content description file) within the content folder can be read into the client's database and requests for program information can be sent from the EPG application to the database engine for execution. Support files such as the artwork and trailer files are not loaded into the database, but rather are read by the EPG application directly from the content folders. For clients that do not support a database engine, metadata can be read directly from the files.

Using Content Folders to Organize Metadata and Media Content

Content folders can also be used to contain not only the pertinent metadata, but the associated media content as well. This use can occur on either the server or the client side. Typically, however, this use will occur with more frequency on the client side.

Recall from FIG. 5 and the discussion above, that the client devices typically receive multiple different content folders that are individually associated with specific media content that has yet to be broadcast. Thus, as noted in FIG. 3, the client devices will typically have a number of these content folder without the associated content. When the content is acquired by the client, as by being broadcast or downloaded (for example in a Personal Video recorder application), the content itself can be added to the content folder so that individual content folders now contain not only pertinent metadata, but the corresponding content as well. Typically, such content can be digitally encoded into an appropriate file (such as an MPEG 2 file) and added to the content folder.

This can be advantageous from the standpoint of being able to abstract a specific piece of media content into an entity (i.e. the content folder) that represents not only the content itself, but a potentially rich user experience made possible by the inclusion of the various types of metadata with the content. Having an abstracted entity that contains not only the content, but the associated metadata as well can be employed in the context of peer-to-peer exchanges. For example, if a user wishes to provide a piece of content to a friend, then they can simply send them the abstracted entity that includes not only the content, but all of the supporting metadata files as well.

Exemplary Client Architecture

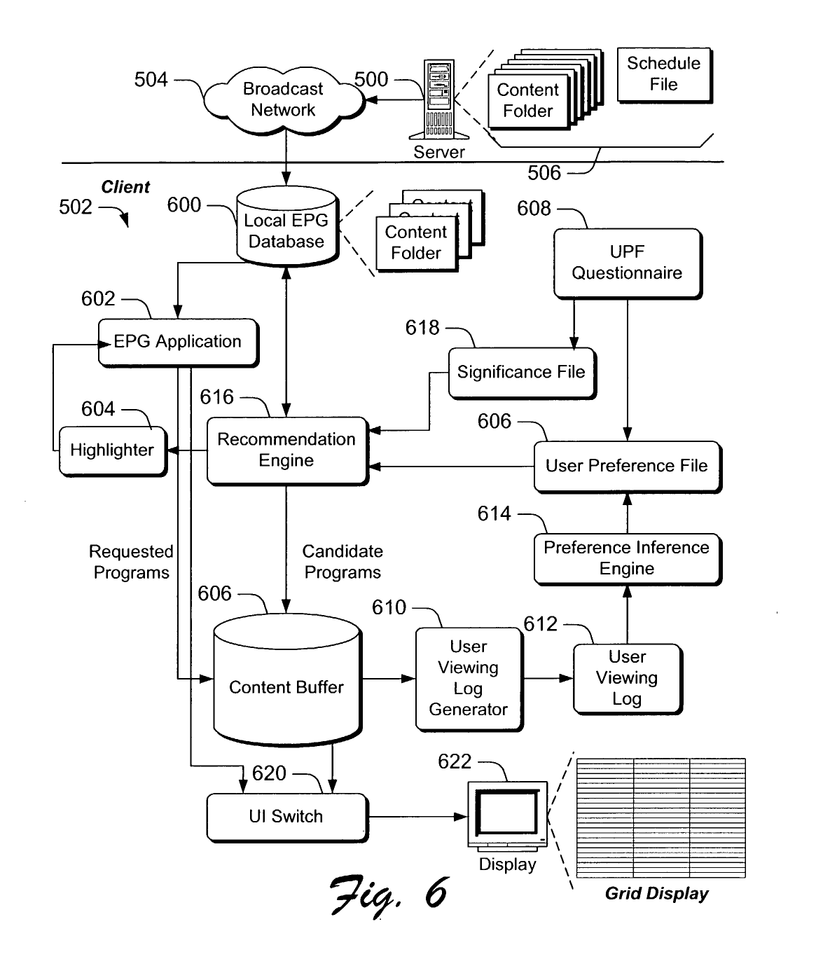

FIG. 6 is a block diagram that illustrates exemplary components of a client system or device 502 in accordance with one embodiment, and expands upon the client device shown and described in FIG. 5. Client system 502 can operate as a user preference recommendation system that can score programs that are available for viewing according to a user's preferences, and recommend certain programs that meet particular conditions that are specific to a particular user.

Client system 502 can include a local electronic programming guide (EPG) database 600 that stores content folders that can include content files, support files and content description files associated with the content files that are downloaded from a server. An exemplary content description file is described in the section entitled “Content Description File” below. Database 600 can also store the schedule file. The database can comprise a traditional database such as that which would reside on a thick client. Alternately, for thin clients, the database would typically be less extensive than for thick clients.

The EPG database 600 provides data to an electronic programming guide (EPG) application 602. The EPG application 602 is configured to enable displays of program names, dates, times, lengths, etc. in a grid-like user interface. A highlighter component 604 can highlight particular programs displayed on an EPG grid. The particular programs that can be highlighted by the highlighter component 604 can be a function of a user's likes and dislikes. Client 502 also includes a content buffer 606 that can store content folders and media content associated with particular content folders. For example, the content buffer can be utilized to store programs that are designated by the user for recording so that the user can later view the program. This will become more apparent in connection with the discussion that appears in the section entitled “Recommendation Lists” below.

The client 502 also includes one or more user preference files (UPF) 606 associated with a user or users of the client. The client 502 can contain more than one user preference file for each user.

The user preference file can be utilized to store values for various attributes of media content (such as television programs). Each attribute value can have a preference value associated with it that indicates how much the particular user likes or dislikes that particular attribute value in a program. Advantageously, the user preference file and the content description file can conform to a common content description schema which can facilitate matching up various programs with the user's preferences. The user preference file 606 can advantageously allow for the separation of the process of establishing user preferences, from the process of matching the user preferences with programs that are available for viewing.

Various techniques can be utilized to populate user preference file 606 with useful information about the user, such as what attribute values of television programs are liked and disliked by the user.

One way to generate a user preference file is to provide the user with a UPF questionnaire 608 that queries the user directly about which attribute values are important to the user. After the user preference file is initially constructed, it can be periodically updated with new information about preferred program attribute values. The user may, for example, simply recall the UPF questionnaire 608 and add additional information or edit information that is already in the file.

Another way to generate a user preference file makes use of a user viewing log generator 610 that monitors programs that are watched by the user or listed by the user for consumption. Program attribute values associated with the monitored programs, together with the time that the program was viewed are logged in a user * viewing log 612. At predetermined intervals, a preference inference engine 614 can build up the user preference file using information contained in the user viewing log 612. User preference files are described in more detail in the section entitled “User Preference File” below.

Client 502 also includes a recommendation or matching engine 616 that drives the comparison of a particular user preference file with content description files associated with programs that are available for viewing.

When recommendation engine 616 determines that an attribute value in the user preference file matches an attribute value found in a content description file, the matching engine 616 can calculate an attribute score for the matching attribute. For example, an “actor” attribute in the user preference file may contain a value of “Steve Martin.” If an “actor” attribute in the content description file also contains the value of “Steve Martin,” then the “actor” attribute is designated as a matching attribute. An attribute score can then be assigned to the matching attribute, and one or more attribute scores assigned in a program can be used to calculate a program score for the program.

In one embodiment, recommendation -engine 616 can make use of a significance file 618 when calculating the scores of a particular program. The significance file can contain significance values that are utilized in the calculation of program scores. Significance files are described in more detail below in the section entitled “Significance Files”.

The output of recommendation engine 616 are various score-based recommendations that can be provided on a user-by-user basis. Various nuances of scoring characteristics and techniques are described below in more detail.

Client 502 can also comprise a user interface (UI) switch 620 and a display 622 such as a television or monitor on which an EPG grid can be rendered. Although the display is shown as being a part of client 502, it is to be appreciated and understood that the display can be separate from the client, such as in the case where the client is embodied in a set top box (STB). The UI switch 620 is effectively used to switch between stored programs in the content buffer 606 and live programs emanating from a content source.

Content Description Schema

As noted above, to facilitate matching attribute values that the user likes (as indicated in their user preference file) with the attribute values of the content programs (as indicated in the content description files) a comprehensive and consistent description schema is used to describe the content.

But one example of an exemplary content description schema that includes metadata categories that correspond to content attributes is described in U.S. patent application Ser. No. 10/125,260, incorporated by reference above.

User Preference File

The user preference file (UPF) is a global file that describes program attributes that the user likes. There is typically one user preference file per user, although users can have more than one user preference file for such things as representing multiple different user personas. In addition to describing the user's likes and dislikes in terms of program attributes, the user preference file can contain other global system attributes that relate to a particular user such as, for example, user interface setup options and programs the user always wishes to have recorded.

Against each program attribute is a preference number that can have a positive value (to indicate a level of desirability associated with content having that attribute), or a negative value (to indicate a level of undesirability associated with content having that attribute). In the example described below, preference numbers can range from −5 to +5.

The user preference file can be implemented in any suitable file format. In the example described below, the user preference file is implemented as an XML file and uses the same schema as the content description files (described in the section entitled “Content Description Files” below) that are used to describe the attributes of the content.

A representation of an exemplary content description schema as employed in the context of a user preference file appears directly below. This representation contains only an abbreviated selection of attributes and attribute values. Accordingly, a typical user preference file can contain more entries than those shown, and/or different attributes and/or attribute values.

<Person Entries>

<PersonName=“Julia Roberts”PersonRole=“Actor”Xpref=“−3”/>
<PersonChar=“Miss Marple”Xpref=“+1”/>
<PersonName=“Ron Howard”PersonRole=“Director”Xpref=“+5”/>

```
  .
  .
  .
<Person Entries>
<Title Entries>
```

<TitleName=“Friday 13”Xpref=“+3”/>
<TitleName=“The Jerk”Xpref=“+5”/>

```
  .
  .
  .
<Title Entries>
  .
  .
```

### Example User Preference File Schema

The user preference file is defined in terms of the same metadata attributes or categories that are used to describe the content in the content description files. The user preference file, however, adds one or more additional attributes that are specific to its associated user. A separate but compatible schema could be used for both the user preference file and the content description file. However, as a content description schema is an evolving concept that can add additional metadata categories over time, it is more desirable, for purposes of synchronization, to have the schemas remain synchronized. Thus, it is desirable to use the same schema for both the content description file and the user preference file.

The excerpt of the user preference file above includes tags that encapsulate various attributes and their associated values. In this specific example, “Person Entries” tags encapsulate attributes and values associated with particular individuals or characters. “Title Entries” tags encapsulates attributes and values associated with particular titles.

The “Person Entries” tag encapsulates a “Person Name” attribute that is used to identify a person such as an actor who is preferred by a particular user. A Person Name attribute value contains a character string such as an actor's name, e.g. “Julia Roberts.” This indicates that the user corresponding to the particular user preference file has a preference -either a like or a dislike—for Julia Roberts in a particular context.

The “Person Entries” tag also encapsulates a “Person Role” attribute that identifies a particular function or context of the person identified in the “Person Name” attribute. This can allow a user to distinguish between actors who may also be directors in some programs. For example, the user may like movies in which Clint Eastwood stars, but may dislike movies in which Clint Eastwood directs. In this particular example, the “Person Role” attribute for Julia Roberts indicates that this entry pertains to Julia Roberts in the context of an actor, and not in some other context.

A preference attribute “Xpref=” is also provided for the “Person Name” and “Person Role” attributes and enables the user to enter a value or preference rating that indicates how much, relatively, the user likes or dislikes the value specified in the “Person Name” attribute for the context defined by the “Person Role” attribute. In this particular example, the user has indicated a value of “−3” for Julia Roberts in the context of an actor.

The “Person Entries” tag also encapsulates a “Person Character” attribute and value, as well as a preference attribute and rating associated with that “Person Character” attribute. The “Person Character” attribute enables a user to identify particular characters that the user likes or dislikes. In the present example, the Person Character attribute value comprises “Miss Marple”, and the preference rating associated with that character is “+1”. This indicates that the user slightly prefers programs in which this character appears.

There can be virtually any number of similar entries encapsulated by the “Person Entries” tag. For example, another “Person Name” attribute is defined for Ron Howard in the context of director and contains a preference rating of “+5”, which indicates a strong preference for programs directed by Ron Howard.

Similarly, the “Title Entries” tags encapsulate “Title Name” attributes and associated values, as well as associated preference attributes and their associated ratings. In this example, a first “Title Name” attribute equals “Friday 13” having an associated preference attribute with a rating of “+2”. A second “Title Name” attribute equals “The Jerk” having an associated preference attribute with a rating of “+5”.

Whether attribute values actually match or not, and the extent to which attribute values match with attributes in the content description files depends on the particular entry type. For example, entry types can be used when exact matches are desired. This might be the case where a user has a particular preference for movie sound tracks in the French language. Yet other entry types can be used when an exact match is not necessarily needed or desired. Such might be the case, for example, when a user is interested in any of the movies in the “Friday the 13^{th}” series of movies. In this case, a match can be deemed to have occurred if the term “Friday 13” appears anywhere in the title of a movie.

Content Description File

Recall that each content folder, such as the one shown and described in FIG. 3, contains a content description file. In the present embodiment, the content description file uses the same schema as does the user preference file. The content of the files, however, can be different. An exemplary portion of a content description file is provided below. The content description file can contain more entries or attributes than those shown below. For example, attributes can include a title attribute, a content identifier attribute, a date of release attribute, a running time attribute, a language attribute, and the like.

<Person Entries>

<PersonName=“Russell Crowe”PersonRole=“Actor”/>
<PersonChar=“John Nash”/>

<Person Entries>
<Title Entries>

<TitleName=“A Beautiful Mind”/>

<Title Entries>

### Example Content Description File Schema

Accordingly, the “Person Entries” tag includes a “Person Name” attribute and value that are used to identify individuals associated with the content. In this particular case, the attribute can be used to designate actors appearing in a particular program. The “Person Entries” tag also includes a “Person Role” attribute and value that identifies a particular function or context of the person identified in the “Person Name” attribute. In this particular example, the “Person Name” and “Person Role” attributes for the content indicates that Russell Crowe is associated with the program in the context of an actor.

The “Person Entries” tag also encapsulates a “Person Character” attribute and value. The “Person Character” attribute identifies particular characters that appear in the program or movie. In the present example, the Person Character attribute value comprises “John Nash”.

Similarly, the “Title Entries” tags encapsulate a “Title Name” attribute and associated value which designates the title of the content. In this example, the “Title Name” attribute equals “A Beautiful Mind”.

As noted above, the user preference file and the content description file contain many of the same attributes. This is due to the fact that the files utilize the same content description schema to describe content attributes. This greatly ii facilitates the process of matching program attributes with a user's preferred attributes.

User Content Preference File

Various embodiments can also make use of user content preference files. A user content preference file is different from a user preference file. Recall that a user preference file is a global file that describes attributes that a user likes and dislikes. A user content preference file, on the other hand, is not a global file. Rather, the user content preference file is associated with each particular piece of content for each user or user preference file. The user content preference files are maintained in the content folder and describe how well a particular piece of content matches up with an associated user preference file. So, for example, if there are four users who use the particular client device, then there should be four User Preference Files that describe each user's likes and dislikes. For each content folder in the client system, then, there should be four User Content Preference files—one for each user describing how well this particular content matches up with the user's likes and dislikes.

User Content Preference files can facilitate the processing that is undertaken by the recommendation engine. Specifically, because of the large number of content folders, user preference files and the like, a recommendation engine can take a long time to execute. In practice, the recommendation engine is executed as a batch process. The results of the recommendation engine can be stored in the user content preference file so that they can be accessed by whatever application may need them.

In addition to indicating how well the particular content matches up with a user's user preference file, the user content preference file can include additional user-specific data that is particular to that piece of content. For example, if the user is a film buff and always wants to ensure that these particular movies are shown in a particular aspect ratio or using Dolby surround sound, such information can be located in the User Content Preference file.

The User Content Preference files can be used to generate human-readable reports that describe how the recommendation engine arrived at a particular score. This can be a desirable feature for more sophisticated users that can assist them in adjusting, for example, their program attribute preferences to refine the recommendations produced by the recommendation engine.

Significance File

Some program attribute matches that are found by the recommendation engine can be more important or significant than others. Significance values, as embodied in a significance file such as significance file 618 in FIG. 6, provide a way for the system to appropriately weight those things that are truly significant to a particular user.

A significance file is a global file that is used to store significance values that correspond to each attribute available in a program. Each significance value denotes a relative importance of the attribute with which it corresponds as compared to the other attributes. Use of significance values provides an appropriate weighting factor when determining whether a program should be recommended to a user or not. That is, when a recommendation engine compares a user's preference file with a content description file and finds a match between particular attribute values, the recommendation engine can multiply the preference 11 rating for the matching attribute in the user's preference file with the corresponding significance value for that attribute in the significance. The product of this operation can then contribute to the overall score of a particular program for purposes of determining whether a recommendation should be made or not.

In accordance with one embodiment, the significance file uses the same schema as the content description file (so that everything stays in synch), and extends the schema by including an additional attribute (“XSignif”) that enables the user to express the significance of a particular attribute of the content description file. As an example, consider the excerpted portion of a significance file that appears directly below.

<Person Entries>

<PersonName=“ ”XSignif-“63”/>
<PersonChar=“ ”XSignif=“87”/>

<Person Entries>
<Title Entries>

<TitleName=“ ”XSignif-“99”/>

<Title Entries>

### Example Significance File Schema

The above significance file excerpt includes a “Person Entries” tag and a “Title Entries” tag. These tags encapsulate many of the same attributes that appear in the user preference file and content description file.

Specifically a “Person Name” attribute is encapsulated by the “Person Entries” tag. Associated with the “Person Name” attribute is a significance attribute “XSignif” that is used to define the relative importance of a person associated with a particular piece of content as compared with other attributes. In this example, a significance value of “63” is assigned to the “Person Name” attribute. Assuming for purposes of this example that significance values range from zero to one hundred, a value of “63” indicates that a match of this attribute is generally important to the user.

A “Person Character” attribute is also encapsulated by the “Person Entries” tag, and the corresponding significance attribute “XSignif” of “87” indicates that a match of this attribute is more important to the calculation of the program score than a match of the “Person Name” attribute.

A “Title Name” attribute is encapsulated by the “Title Entries” tag and, in this example, an associated significance attribute “XSignif” of “99” indicates that a match of this attribute is even more important than a match of the “Person Character” attribute.

It should be noted that the significance values could be stored in the user preference files along with each entry therein, thereby making the significance values user specific rather than system wide. They could even be associated with the particular preferences, however, doing so would require redundant entries since some attributes may be repeated with different attribute values. For example, a user preference file may include fifty actors' names that a user prefers to see. If the significance values were to be included in the user preference file associated with particular preferences, then each of the fifty entries for actors' names would have to include the same significance value. Thus, by virtue of the fact that the significance file is a global file, such redundancies can be avoided.

Additionally, it should be appreciated that it is not necessary for the user to create and/or have control over the significance file. Rather, another entity such as content provider may assign the significance values for a particular client system. While such an implementation would not provide as close a fit with each user's personal preferences, it would relieve the user from having to individually do the work.

As an example of how a client device or system can employ a significance file and significance values, consider the following. Assume that in a user's preference file the user includes the same rating or preference value (e.g. +5) for the “Title Name” and “Person Character” attributes. For example, perhaps the “Title Name” of concern is the “Seinfeld” show and the “Person Character” of interest is the Kramer character. Thus, in this instance, the user really likes the Seinfeld show and the Kramer character. Notice in the excerpted portion of the significance file that appears above, the “Title Name” attribute has a significance value of “99”, while the “Person Character” attribute has a significance value of “87”. Thus, although the user may enter the same preference value for the Title Name attribute value and the Person Character attribute value (i.e. +5) because the user strongly prefers both, all other things being equal, by using the significance file the system would determine that this user prefers a Seinfeld episode that features the Kramer character (with a corresponding score of 5*87+5*99=930) over a Seinfeld episode that does not feature the Kramer character (with a corresponding score of 5*99=495).

For many of the program attribute types, the significance file can have multiple numbers, each tagged with the type of match to which they relate. The most commonly used tags can be “Full” and “Part” which refer respectively to a 11 full match or just a partial match. Finding a keyword within a plot abstract is an example of a partial match.

Running the Recommendation Engine

Typically, the recommendation engine is run or otherwise executed for every piece of content for every user on the client system. Needless to say, this can involve a fairly large amount of processing for the client system. Various strategies can be used on the client to effectively hide this processing time. This can be particularly important in the context of client devices that do not employ high end processors.

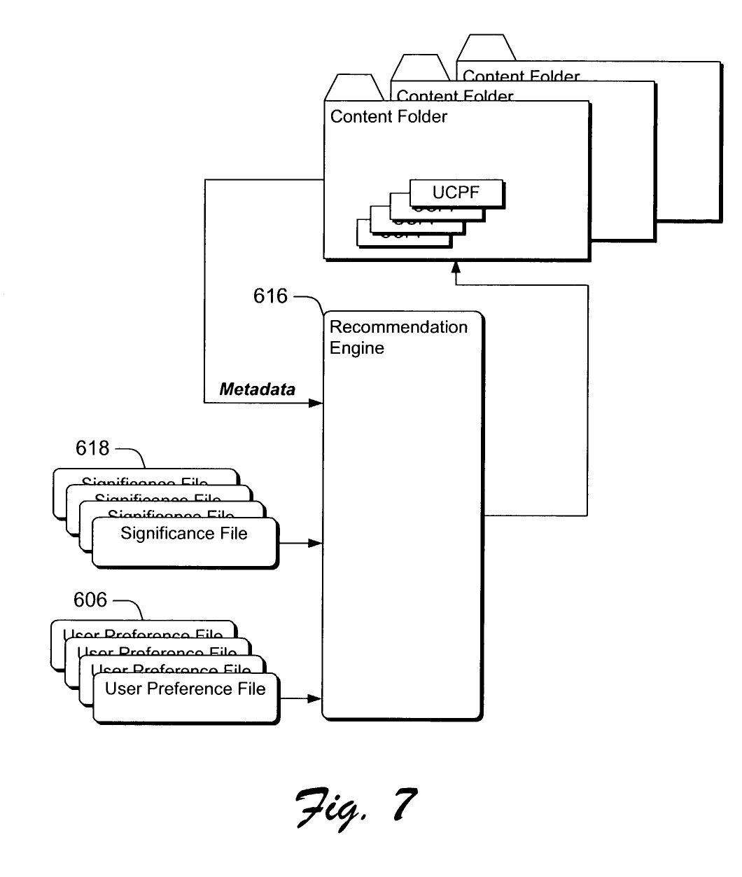

As an example, consider FIG. 7 which illustrates, in somewhat more detail, the processing that can take place at the recommendation engine 616. Typically, there are a number of different inputs to the recommendation engine. Here, the inputs can include the metadata from each of the content folders, the input from each user's associated significance file 618, and the input from each user's preference file 606. For each piece of content that the client receives (i.e. for each content folder), the recommendation engine is run with these inputs. The recommendation engine 616 processes inputs and then provides an output that includes, among other things, the scores for the various programs, for each user, that are slated for broadcasting during the next period of time. This data can be provided by the recommendation engine into user content preference files (UCP files) that are contained in each of the content folders. Additionally, the recommendation engine's output is also used to make recommendations for the various users via the EPG that is generated and displayed for the users. Those programs that more closely match a particular user's likes can be displayed more prominently than those program that do not closely match a user's likes.

In accordance with one embodiment, recommendation engine 616 can be run or executed as the content description information (i.e. the content folders) are downloaded from the server. Downloading of the content folders can be scheduled such that the content folders are downloaded at a time when the users are not likely to be using the client system, e.g. very early in the morning. Typically, content folders that are downloaded are associated with content that is to be broadcast up to a couple of weeks into the future. Downloads can be scheduled for once a day such that if for some reason a download does not happen on a particular day, the next day's download can catch up. In practice, it is usually sufficient for downloads to occur at least once a week so that the user's experience is not disrupted. Accordingly, scheduling downloads for every day can provide plenty of room to account for such things as bandwidth limitations and the like.

Thus, typically, the recommendation engine can be scheduled to run every night. In some situations, it can be desirable to immediately run the recommendation engine if, for example, something in the client system changes that would make running the recommendation engine desirable. For example, assume that a user is watching a particular program and something or someone in the program catches their eye. Perhaps they notice a new actor whom they really like. The user may opt to update their user preference file to reflect that they would like to have more recommendations made for any programs in which this particular actor appears. Here, then, it can be desirable to immediately run the recommendation engine to incorporate the user's new changes in their user, preference file. This can provide the user with immediate feedback and recommendations. In practice, however, this may be unnecessary because the user's change may not necessarily change the overall scores very much.

Sorting the Scores

During the download of content description data (i.e. content folders), recommendation engine 616 calculates a score for each program. At the end of the complete process, the recommendation engine can sort the scores for all of the, programs so that it is later able to display a sorted list of recommendations to the user. This list of sorted scores can be kept in a separate scores file. The scores file can include a list of the MCIDs for each of the programs and the corresponding score for each MCID. Each user can have a separate scores file that contains their own scores for the various programs. Using only an MCID is sufficient in this case because with the MCID, all other relevant information pertaining to a particular program can be accessed.

The scores file can be stored as part of the user preference file, or in an accompanying file that is associated with the user. The latter would go far to ensure that the user preference file does not become too bloated.

Privacy Issues

Because the user preference files and scores files contain sensitive information, various protections can be utilized to ensure that the user preference files and, if a separate file—the scores files—are protected.

To protect the user preference and scores files, the files can be encrypted and access to the files can be via password. Any suitable encryption techniques can be utilized such as DES or AES security techniques. Other methods of protection can be utilized such as storing the files on a removable smartcard.

Relative Scoring

As noted above, each program that is to be broadcast in a forthcoming schedule is given a score by the recommendation engine. The actual score that each program receives is not as important as the score's significance relative to all of the other scores. That is, it is more useful to assess the scores of each program relative to the scores for the other programs. Thus, it can be advantageous to translate each program's actual score into a relative score so that its importance to the individual users can be ascertained relative to the other programs that are to be broadcast.

In accordance with one embodiment, the recommendation engine computes a score for each of the programs that are to be broadcast. The recommendation engine then takes this score and computes a relative score that provides a measure of how one particular program relates all of the other programs that are to be broadcast. One way of computing a relative score is to divide each program's individual score by the highest score found for any program in the forthcoming schedule. To facilitate this calculation, the recommendation engine can, at the conclusion of the download and metadata matching processes, determine the highest score and save this score in a global location, e.g. in a particular user's user preference file. As further individual scores are computed for each of the programs for each of the users, each program's relative score can be computed as well.

It can be advantageous to translate each program's relative score into a ii useful visual display that can be readily utilized by a user for selecting programs. For example, a star rating system can be utilized. One way of implementing a star rating system can be as follows. Programs that receive a negative score (and hence are not desirable from a user's standpoint) will not receive a recommendation star. Similarly, programs that receive scores that are less than typically about half of the highest score will not receive a recommendation star. Various thresholds can be used to ascertain how many stars a program is to receive. It can be desirable for the thresholds associated with the different star ratings to be user programmable so that individual users can define how stars are to be assigned. As an example, consider the following exemplary threshold settings and associated stars:

| 0-50% (and negative scores) | No star |
|---|---|
| 50-60% | One star |
| 60-70% | Two stars |
| 70-80% | Three stars |
| 80-90% | Four stars |
| 90-100% | Five stars |

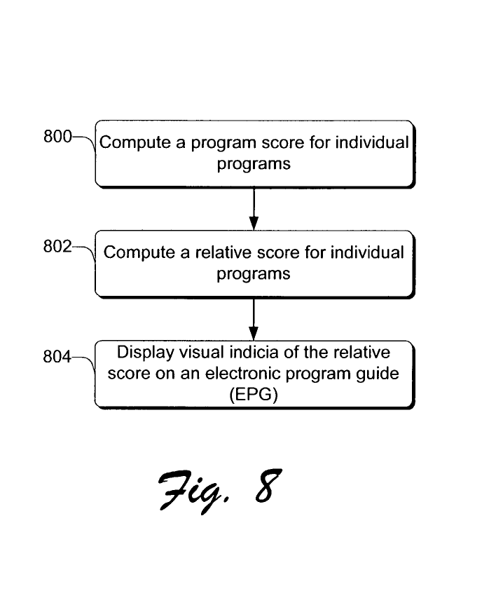

FIG. 8 is a flow diagram that describes steps in a method in accordance with one embodiment. The method can be implemented in any suitable hardware, software, firmware or combination thereof. In the illustrated example, the method can be implemented in connection with an EPG system such as the one discussed above.

Step 800 computes a program score for individual programs that are to be represented in an electronic program guide. Program scores can be computed in any suitable way. One way of computing program scores is described in this document and the others that have been incorporated by reference above. In those systems, computation of the program scores is performed by a recommendation engine that can compute scores as a function of metadata that describes media content and preferences that have been expressed by users in terms of a user preference file. Step 802 computes, from the program score for each program, a relative score for that program. The relative score provides a measure of how well a particular program relates to the other programs that are to be broadcast. One way of computing a relative score is described just above. Step 804 then displays visual indicia of the relative score on an EPG. This step can be implemented by rendering an EPG and providing, within or associated with individual cells of the EPG, the visual indicia for an associated program. Any suitable visual indicia can be utilized. For example, the visual indicia can comprise a number that reflects the relative score, one or more symbols (such as a star or a number of stars), or a color that is associated with or used to accent individual cells (e.g. green cells indicate highly recommended programs, yellow cells indicate program of moderate or little interest, and red cells indicate programs that are not recommended).

Filter Tokens

As noted above, filter tokens can be used for two separate but related purposes. First, filter tokens can be used to reduce the amount of non-useful information displayed in an electronic program guide to effectively and efficiently reduce information overload. Second, filter tokens can be used to specify preferences for combinations of program attributes in a User Preference File. Each of these uses is individually discussed in its own designated section below.

A filter token can comprise a Boolean combination of program attributes and instance attributes. The program attributes are as specified by a content description schema, and the instance attributes are as specified by an instance description schema, both of which are discussed above.

In accordance with the described embodiments, for each use of the filter token mentioned above, the filter token is specified using the same basic syntax. This provides an added degree of flexibility. In the EPG environment, filter tokens provide a mechanism for reducing the amount of information that appears in an EPG display. Filter tokens can also be exchanged with others, much like any ordinary file. This can enable users to share what they believe is important in the EPG context (i.e. what programs to include or exclude from the EPG display) with others, including their friends. In the User Preference environment, filter tokens provide a mechanism for providing sophisticated information to the recommendation engine and, as such, facilitates and improves the program recommendation process.

Filter tokens can also serve as a foundation or template from which a user can further reflect their own preferences. For example, filter tokens can be downloaded from a third party and a user can then modify the filter token to more closely reflect their own preferences. As an example, a third party Web service may offer filter tokens to registered members as a way of helping the users develop their own collection or cache of filter tokens.

Exemplary Filter Token Format

In accordance with one embodiment, filter tokens constitute individual files that can be saved on a client device and used by the various users. In the illustrated and described embodiment, a filter token is defined in terms of a tag-based, hierarchical file. An exemplary tag-based hierarchical file comprises an Extensible Markup Language (XML) file, an example of which is given below.

<?xml version=“1.0”?>
<FilterToken xmlns=“http://tempuri.org/FilterTokenschema.xsd”>

<Include>

<AND>

<Format Value=“Video_-_Movie_Cinema_Released”/>
<OR>

<AvailabilityDate Value=“2002”/>
<AvailabilityDate Value=“2001”/>
<AvailabilityDate Value=“2000”/>
<AvailabilityDate Value=“1999”/>

</OR>
<NOT>

<ExtendedCensorRatingViolence Value=“Extreme”/>

</NOT>

</AND>

</Include>
<Exclude>

<OR>

<Channel Value=“483”/>
<Channel Value=“486”/>
<Channel Value=“631”/>
<Channel Value=“672”/>
<Person Name=“Bert Reynolds”/>

</OR>

</Exclude>

</FilterToken>

### Exemplary Filter Token File

Notice in the above XML file format, there are a number of tags that are used to encapsulate other tags, attributes and associated attribute values. For example, at the top level of the XML tree, there are “Include” and “Exclude” tags. The purpose of these tags is to either include or exclude information encapsulated by the tags. This will become more evident below as “Inclusory” and “Exclusory” filter token types are described. These tags, however, can be thought of as a convenient way to specify a top level “NOT” function.

Notice that the “Include” and “Exclude” tags can encapsulate additional tags. When it is desirable to require that all of a set of attributes have the specified values, then the “AND” tag is used to encapsulate the attributes and their values. When it is desirable for only one of the specified attribute specifications to be true, then the “OR” tag is used to encapsulate the attributes and their associated values. To require that the attribute is not the value specified, then that line (or lines) is encapsulated by the “NOT” tag.

The XML file appearing above can be interpreted as follows: the programs shown will all be movies made in 1999 or 2000 or 2001 or 2002 provided that they do not have extreme violence and they are not on channels 483, 486, 631 or 672 and provided that they do not have Burt Reynolds in them.

Thus, filter tokens can provide a very powerful tool to define program and instance attributes to drive the EPG and program recommendation processes.

Using Filter Tokens in an Electronic Program Guide

Displays for electronic program guides typically have too much information for users. This is not surprising given that many systems provide information for hundreds of channels for periods of about two weeks into the future. This constitutes many tens of thousands of programs and can very easily overload users with much more information than they need or desire.

The reality is that a high percentage of the programs in the EPG will never be of interest to a particular user. What is needed is a way of filtering out the programs that are not of interest to individual users. The user can then browse through the information about just those programs that stand a good chance of being applicable to them.

Filter tokens can be used to drastically cut down on the information that is utilized within an EPG display. The process of defining the filter tokens can, however, be a time-consuming process. For less technically sophisticated users, defining filter tokens may not be as desirable a process as one would like.

In accordance with one embodiment, filter tokens can be shared amongst users. This enables filter tokens to be pre-defined by third parties and then tweaked by individual users to more closely fit their requirements and preferences. Ordinary users can install filter tokens from trusted sources, such as friends and trusted third parties, where they perceive that the person who created the filter token has similar interests and perspectives as them.

Exclusionary and Inclusionary Filter Tokens

In accordance with some of the described embodiments, filter tokens in the EPG context can be either or both of “Exclusionary” or “Inclusionary”.

In the case of an “Exclusionary” filter token, programs that conform to the conditions specified by the filter token are removed or excluded from the EPG display, i.e. such programs are not displayed. A simple Exclusionary filter token may just specify program channels that should not be included in the grid. Such a filter token may specify, for example, that the EPG should filter out the religious TV channels, the Pay Per View Channels, the shopping channels, and the children's channels. In the XML file example above, the “Exclude” tag would have the effect of excluding, from the EPG display, any programs appearing on channels 483, 486, 631, or 672, as well as those programs in which Bert Reynolds appears.

In the case of an “Inclusionary” filter token, programs are removed from the EPG display apart from the ones that conform to the conditions specified in the filter token. In the XML file example above, the “Include” tag would have the effect of including movies that were available in 1999 or 2000 or 2001 or 2002, provided that the movies do not contain extreme violence

In the illustrated and described embodiment, the filter tokens can be specified using any attributes from the content description schema and any attributes from the instance description schema. These schemas are described in more detail in application Ser. Nos. 10/125,260 and 10/125,259, incorporated by reference above.

Advantageously, a filter token can have both Inclusionary and Exclusionary aspects to it. The XML file example above provides a good illustration of this concept.

Cumulatively Applying Filter Tokens

In accordance with one embodiment, filter tokens can be applied cumulatively. That is, a first filter token can be applied to reduce the amount of information in an EPG display, after which a second filter token can be applied and so on. In the above example, rather than having a filter token with both “Inclusionary” and “Exclusionary” sections, the same effect can be achieved by applying the two previously described filter tokens cumulatively. Additionally, those two separate filter tokens could have come from two completely separate sources, e.g. two different people whom the user trusts.

As another example, consider that the user might receive one filter token that asks for movies that have been made some time in the last three years. The user might have received another filter token, obtained from perhaps a different source, that might ask for programs that have one or more of a specified list of actors. If the user chooses to apply both filter tokens, then the EPG display will contain just information on the recent movies that star those actors.

Accordingly, cumulative application of filter tokens in an EPG environment provides a powerful way to reduce the information displayed to just that information of interest to the user or users.

Installing Filter Tokens in an EPG Application

Filter tokens, which can be thought of as pre-programmed searches, can be installed in, and displayed for a user by an EPG application in any suitable way. For example, one useful way to incorporate and install filter tokens for a user is to assign or allocate the individual filter tokens to individual function buttons such as a “Favorites” buttons in the EPG application. This way, the user can have quick access to the filter tokens. As an example, a user can install a filter token by right clicking on a “Favorite” button, browsing to an available filter token (e.g. a filter token XML file), and then installing it behind the “Favorite” button. When a user is sent a filter token as, for example, an email attachment, they can simply save the filter token to disk, browse to it from the EPG application, and install it behind a “Favorite” button.

When the EPG application starts up, typically all of the channels and programs will be displayed. By left clicking on the various “Favorite” buttons, the filter tokens can be cumulatively applied by the user to reduce the information displayed to just the information of interest to the user. Left clicking the favorite button again can remove that particular filter token.

As noted above, filter tokens can be shared between friends. For example, one friend sets up a filter token and emails it to his friends. While this is quite useful, filter tokens can be much more widely available. For example, a fan site on the Internet might decide to post a filter token that finds all the programs that star a particular person. For example, a Russell Crowe fan site might make available a filter token that finds all programs that contain Russell Crowe (i.e. movies, talk shows, interviews, and the like). Alternately, a school's web site might make available a filter token that finds all of the programs that are applicable to this term's class syllabus. Thus, if the syllabus for a particular class focuses on the Revolutionary War, then a filter token can be provided that finds all programs associated with the Revolutionary War.

Reducing Blanks in the EPG Display

When an EPG display is constructed by the application on the client device, the application can automatically reduce the grid to try to avoid blank spaces. As Man example, if a filter token provides that only movies in a particular date range are to be displayed by the EPG, and it turns out that a particular channel does not have any programs that conform to these requirements, then the application can remove that channel from the EPG display. This can significantly reduce the size of the grid matrix and can avoid requiring the user having to scroll over large distances to see the applicable programs.

Security

Unlike tokens that can be used to specify that a particular program should be recorded, filter tokens are not used to automatically program a personal video recorder. Accordingly, there is no need to limit the source addresses from which filter tokens are accepted. A user can chose to install, to a function button, just those filter tokens that they wish to use.

Using Filter Tokens in a User Preference File

Recall from the discussion above, that a User Preference File contains a list of program attributes together with a preference value against each attribute. User Preference Files can be used by the recommendation engine to generate a list of program recommendations for particular users or groups of users.

The User Preference File might, for example, contain a list of actors and actresses, each with a preference value. The User Preference File might also contain a list of the genres that a particular user likes, together with a preference value against each. The preference values can be positive to indicate a liking for content where that attribute is true, or negative in the case of program attributes that are not liked.

Filter tokens extend this concept to allow for Boolean combinations of attributes to be assigned a preference value. For example, a particular user may like movies that star Clint Eastwood, but only if they are violent movies (e.g. the user does not like movies such as “Bridges of Madison County”). A filter token can then be used that specifies both Actor=“Clint Eastwood” and ExtendedCensorRatingViolence =“Significant”, and which carries a preference value to indicate the user's preference for such movies. An exemplary excerpt of an XML file that represents this user's particular preference is set forth below:

<FilterToken Xpref=“+4”>

<AND>

<Person Actor=“Clint Eastwood”/>
<ExtendedCensorRatingViolence Value=“Significant”/>

</AND>

</FilterToken>

The filter token can exist as a stand alone XML file that can be shared with others, or it can comprise part of the User Preference File that is built up for a particular user.

Filter tokens can be specified using any suitable techniques or user interfaces. But one example for enabling a user to specify filter tokens is described below. Other more automated methods can, however, be used to specify filter tokens for a particular user. For example, the user's viewing log can be analyzed to extract program attribute combinations that are found to be common to programs that are frequently watched by that particular user.

In the illustrated and described embodiment, in order to select a preference value, a combo box is used to allow a value in the range of −5 to +5 to be specified for various attributes. As an example, consider FIG. 9 which shows a user interface component 900 that enables a user to enter preference values for various attributes. Here, the user has entered a preference value of “+4” for Winona Ryder. This preference value will be used to calculate a score for programs that include Winona Ryder.

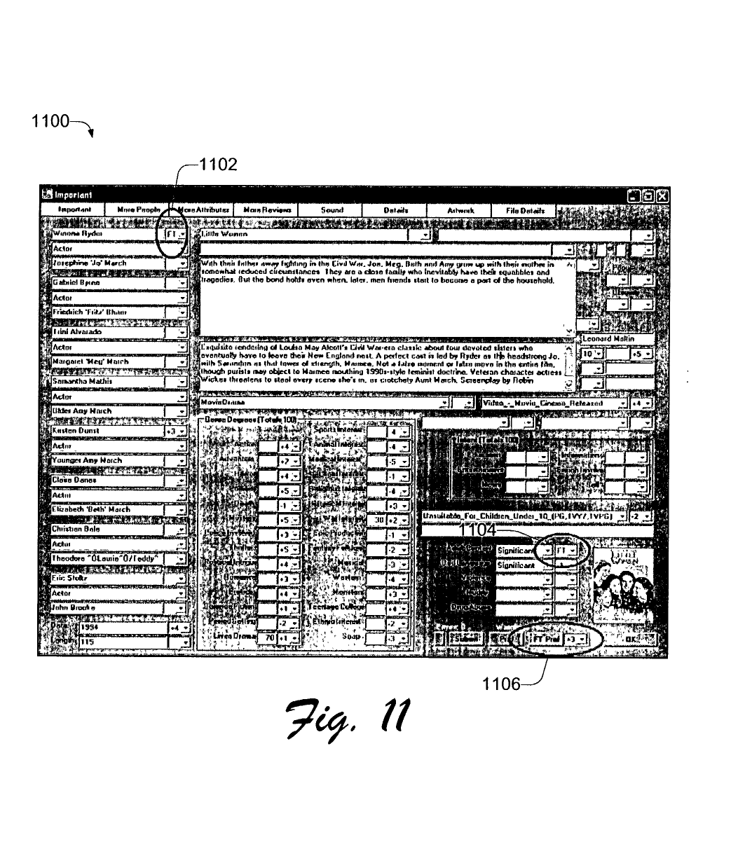

In a similar fashion, filter tokens can be specified using the same type of user interface. As an example, consider FIG. 10 which shows a user interface component 1000 that enables the user to specify filter tokens. Here, instead of designating a preference value for a particular attribute, the user can designate that the attribute is to comprise part of a filter token by selecting “FT” as a filter token designation. Here, for example, the user is about to select the “FT” designation to incorporate Winona Ryder into a filter token.

FIG. 11 shows a large user interface component 1100 of which the FIG. 10 component comprises a part. The “FT” value can be specified for any number of program attributes. In this example, the effect of specifying an “FT” value is to create an “AND” function. Once an “AND” function has been established, a preference value can be applied to the combination being true. This is entered in a global position on the entry screen and the preference is stored away in the User Preference File. In the present example, the “FT” value has been selected for Winona Ryder at 1102 and the “FT” dvalue has been selected for Significant Adult Content at 1104. Additionally, a preference value of “+3” has been selected for the filter token at 1106.

When the recommendation engine sees that a particular piece of content has the necessary program attributes to make the filter token true as per its definition, is it will then take the global preference specified for that filter token and it will contribute towards the score for that piece of content. Thus, when the recommendation engine sees that a particular piece of content has Winona Ryder in it and that the content includes significant adult content, this particular piece of content will have a score calculated for it using the preference value of “+3”. It will then be further evaluated in relation to the other programs for which scores have been calculated for purposes of determining whether the program is to be recommended to a particular user.

The specific XML produced by the above example is as follows:

<FilterToken XPref=“+3”>

<AND>

<Person Actor=“Winona Ryder”/>
<ExtendedCensorRatingAductContent Value=“Significant”/>

</AND>

</FilterToken>

In the same way that a user can receive filter tokens from a friend or download site to help the user filter information in an electronic program guide, the user can also receive or download filter tokens to add to their User Preference File. This can allow the user to tell the recommendation engine that they would like a very specific type of programming.

Exemplary Method

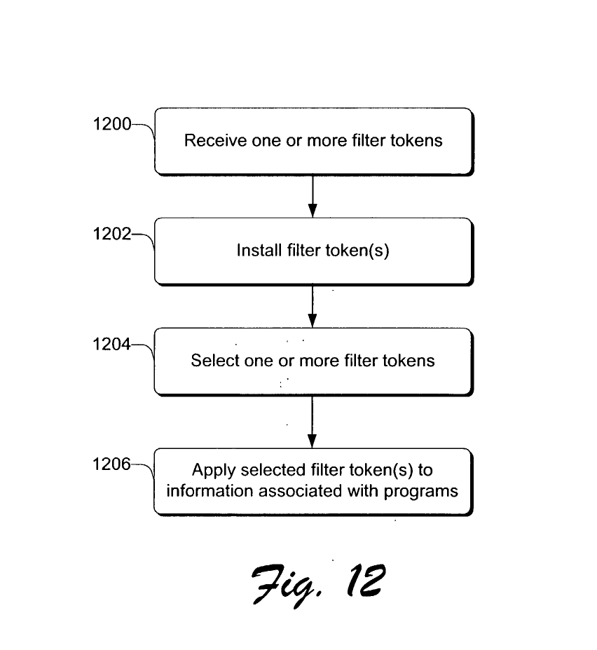

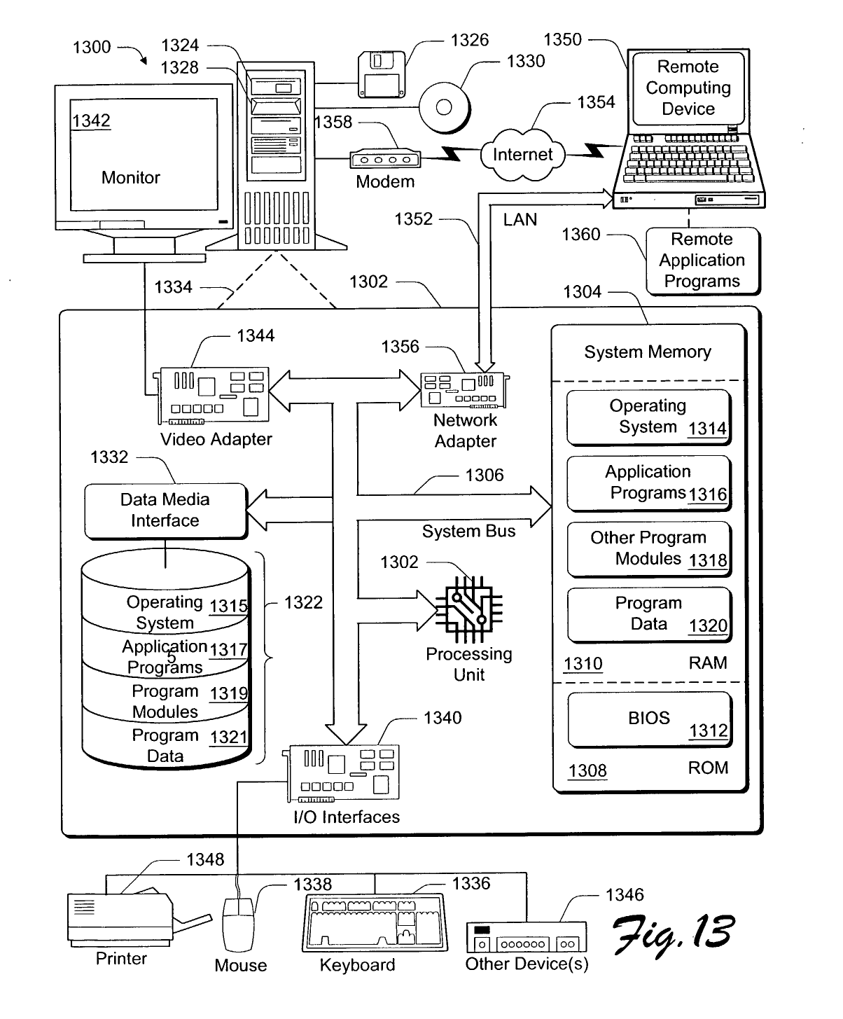

FIG. 12 is a flow diagram that describes steps in a method in accordance with one embodiment. The method can be implemented in any suitable hardware, software, firmware or combination thereof In the illustrated example, the method can be implemented in connection with an EPG system such as the one discussed above.

Step 1200 receives one or more filter tokens. Examples of filter tokens and their various component parts are provided above. The filter tokens can be received in any suitable way. For example, the filter tokens can be exchanged between friends or users of various EPG systems. Alternately or additionally, the filter tokens can be received from third parties such as web services or various web sites sponsored by others. Step 1202 installs the filter token(s) on a client device. Installation of the filter token(s) can be accomplished in any suitable way. But one example of how filter tokens can be installed is given above. Step 1204 selects one or more filter tokens. This step can be performed by the client device receiving user input that indicates that they desire to use one or more of the filter tokens within the context of the EPG system.

Step 1206 applies selected filter token(s) to information associated with programs that are associated with the EPG system. This step can be implemented in a couple of different ways. First, application of the filter tokens to various program and/or instance attributes can reduce the amount of information that is ultimately rendered in an EPG display for the user. This step can include eliminating entire channels on the EPG display if the channels do not contain the appropriate information as specified by the user's filter tokens. Second, application of the filter tokens can take place by using any filter tokens in a particular User Preference File to filter through program and instance attributes so that the EPG system can make various program recommendations to the user.

Exemplary Computer Environment

The various components and functionality described herein can be implemented with a number of individual computers that serve as client devices. FIG. 13 shows components of a typical example of such a computer generally at 1300. The components shown in FIG. 13 are only examples, and are not intended to suggest any limitations as to the scope of the claimed subject matter.

Generally, various different general purpose or special purpose computing system configurations can be used. Examples of well known computing systems, environments, and/or configurations that may be suitable for use in implementing the described embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Various functionalities of the different computers can be embodied, in many cases, by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 13, the components of computer 1300 may include, but are not limited to, a processing unit 1302, a system memory 1304, and a system bus 1306 that couples various system components including the system memory to the processing unit 1302. The system bus 1306 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Computer 1300 typically includes a variety of computer-readable media. Computer-readable media can be any available media that can be accessed by computer 1300 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1300. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 1304 includes computer storage media in the form of volatile and/or nonvolatile memory such as read only memory (ROM) 1308 and random access memory (RAM) 1310. A basic input/output system 1312 (BIOS), containing the basic routines that help to transfer information between elements within computer 1300, such as during start-up, is typically stored in ROM 1308. RAM 1310 typically contains data and/or program modules that are immediately accessible to and/or presently being operated on by processing unit 1302. By way of example, and not limitation, FIG. 13 illustrates operating system 1314, application programs 1316, other program modules 1318, and program data 1320.

The computer 1300 may also include other removable/non-removable, volatile/nonvolatile computer storage media. By way of example only, FIG. 13 illustrates a hard disk drive 1322 that reads from or writes to non-removable, nonvolatile magnetic media, a magnetic disk drive 1324 that reads from or writes to a removable, nonvolatile magnetic disk 1326, and an optical disk drive 1328 that reads from or writes to a removable, nonvolatile optical disk 1330 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1322 is typically connected to the system bus 1306 through a non-removable memory interface such as data media interface 1332, and magnetic disk drive 1324 and optical disk drive 1328 are typically connected to the system bus 1306 by a removable memory interface such as interface 1334.

The drives and their associated computer storage media discussed above and illustrated in FIG. 13 provide storage of computer-readable instructions, data structures, program modules, and other data for computer 1300. In FIG. 13, for example, hard disk drive 1322 is illustrated as storing operating system 1315, application programs 1317, other program modules 1319, and program data 1321. Note that these components can either be the same as or different from operating system 1314, application programs 1316, other program modules 1318, and program data 1320. Operating system 1315, application programs 1317, other program modules 1319, and program data 1321 are given different numbers here to illustrate that, at a minimum, they are different copies. A user may enter commands and information into the computer 1300 through input devices such as a keyboard 1336 and pointing device 1338, commonly referred to as a mouse, trackball, or touch pad. Other input devices (not shown) may include a microphone, joystick, game pad, satellite dish, scanner, or the like. These and other input devices are often connected to the processing unit 1302 through an input/output (I/O) interface 1340 that is coupled to the system bus, but may be connected by other interface and bus structures, such as a parallel port, game port, or a universal serial bus (USB). A monitor 1342 or other type of display device is also connected to the system bus 1306 via an interface, such as a video adapter 1344. In addition to the monitor 1342, computers may also include other peripheral output devices 1346 (e.g., speakers) and one or more printers 1348, which may be connected through the I/O interface 1340.

The computer may operate in a networked environment using logical connections to one or more remote computers, such as a remote computing device 1350. The remote computing device 1350 may be a personal computer, a server, a router, a network PC, a peer device or other common network node, and typically includes many or all of the elements described above relative to computer 1300. The logical connections depicted in FIG. 13 include a local area network (LAN) 1352 and a wide area network (WAN) 1354. Although the WAN 1354 shown in FIG. 13 is the Internet, the WAN 1354 may also include other networks. Such networking environments are commonplace in offices, enterprise-wide computer networks, intranets, and the like.

When used in a LAN networking environment, the computer 1300 is connected to the LAN 1352 through a network interface or adapter 1356. When used in a WAN networking environment, the computer 1300 typically includes a modem 1358 or other means for establishing communications over the Internet 1354. The modem 1358, which may be internal or external, may be connected to the system bus 1306 via the I/O interface 1340, or other appropriate mechanism. In a networked environment, program modules depicted relative to the computer 1300, or portions thereof, may be stored in the remote computing device 1350. By way of example, and not limitation, FIG. 13 illustrates remote application programs 1360 as residing on remote computing device 1350. It will be appreciated that the network connections shown are exemplary and other means of establishing a communications link between the computers may be used.

### CONCLUSION

The various embodiments described above can greatly facilitate the manner in which an EPG system can offer services to users. The services can be very specifically tailored to individual users or groups of users.

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. A method comprising:
defining a Boolean combination of attributes associated with one or more programs that are subject to representation in an electronic program guide display, said combination being defined in a manner that permits the combination to be electronically exchanged between different client devices; and
using the Boolean combination of attributes to reduce an amount of information that is provided to a user of an electronic program guide system embodying the display.

2. The method of claim 1, wherein the act of using comprises reducing the amount of information that is displayed in the electronic program guide display.

3. The method of claim 1, wherein the act of using comprises reducing the amount of information that is used to make program recommendations to a user.

4. The method of claim 1, wherein the act of defining the Boolean combination comprises using a hierarchical file structure to define the combination.

5. The method of claim 4, wherein the hierarchical file structure comprises a tag-based structure.

6. The method of claim 4, wherein the hierarchical file structure comprises an XML file.

7. The method of claim 1, wherein the act of using comprises incorporating one or more Boolean combinations into a user preference file for specifying preferences of combinations of attributes, the user preference file being configured for use in computing scores for one or more of the programs.

8. One or more computer-readable media embodying computer-readable instructions which, when executed by one or more processors, cause the one or more processors to implement the method of claim 1.

9. A system comprising:
one or more processors;
one or more computer-readable media embodying computer-readable instructions which, when executed by the one or more processors, cause the one or more processors to:
define a Boolean combination of attributes associated with one or more programs that are subject to representation in an electronic program guide display, said combination being defined in a manner that permits the combination to be electronically exchanged between different client devices; and
use the Boolean combination of attributes to reduce an amount of information that is provided to a user of an electronic program guide system embodying the display.

10. The system of claim 9, wherein instructions cause the one or more processors to reduce the amount of information that is displayed in the electronic program guide display.

11. The system of claim 9, wherein instructions cause the one or more processors to reduce the amount of information that is used to make program recommendations to a user.

12. The system of claim 9, wherein instructions cause the one or more processors to define the Boolean combination using a hierarchical file structure to define the combination.

13. The system of claim 9, wherein instructions cause the one or more processors to define the Boolean combination using a hierarchical, tag-based file structure to define the combination.

14. The system of claim 9, wherein instructions cause the one or more processors to define the Boolean combination using an XML file structure to define the combination.

15. A method comprising:
receiving a Boolean combination of attributes associated with one or more programs that are subject to representation in an electronic program guide display, said combination being defined in a manner that permits the combination to be electronically exchanged between different client devices; and
using the Boolean combination of attributes to reduce an amount of information that is provided to a user of an electronic program guide system embodying the display.

16. The method of claim 15, wherein the act of using comprises reducing the amount of information that is displayed in the electronic program guide display.

17. The method of claim 15, wherein the act of using comprises reducing the amount of information that is used to make program recommendations to a user.

18. The method of claim 15, wherein the act of receiving the Boolean combination comprises receiving a hierarchical file structure defining the combination.

19. The method of claim 15, wherein the act of receiving the Boolean combination comprises receiving a hierarchical file structure defining the combination, the hierarchical file structure comprising a tag-based structure.

20. The method of claim 15, wherein the act of receiving the Boolean combination comprises receiving a hierarchical file structure defining the combination, the hierarchical file structure comprising an XML file.

21. The method of claim 15, wherein the act of using comprises incorporating one or more Boolean combinations into a user preference file for specifying preferences of combinations of attributes, the user preference file being configured for use in computing scores for one or more of the programs.

22. The method of claim 15, wherein the act of receiving comprises receiving the Boolean combination via a network.

23. The method of claim 15, wherein the act of receiving comprises receiving the Boolean combination via the Internet.

24. The method of claim 15, wherein the act of receiving comprises receiving the Boolean combination via a third party.

25. One or more computer-readable media embodying computer-readable instructions which, when executed by one or more processors, cause the one or more processors to implement the method of claim 15.

26. A system comprising:
one or more processors;
one or more computer-readable media embodying computer-readable instructions which, when executed by the one or more processors, cause the one or more processors to:
receive a Boolean combination of attributes associated with one or more programs that are subject to representation in an electronic program guide display, said combination being defined in a manner that permits the combination to be electronically exchanged between different client devices; and
use the Boolean combination of attributes to reduce an amount of information that is provided to a user of an electronic program guide system embodying the display.

27. The system of claim 26, wherein the instructions cause the one or more processors to reduce the amount of information that is displayed in the electronic program guide display.

28. The system of claim 26, wherein the instructions cause the one or more processors to reduce the amount of information that is used to make program recommendations to a user.

29. The system of claim 26, wherein the instructions cause the one or more processors to receive the Boolean combination as a hierarchical file structure defining the combination.

30. The system of claim 26, wherein the instructions cause the one or more processors to receive the Boolean combination as a hierarchical tag-based file structure defining the combination.

31. The system of claim 26, wherein the instructions cause the one or more processors to receive the Boolean combination as a hierarchical file structure defining the combination, the hierarchical file structure comprising an XML file.

32. The system of claim 26, wherein the instructions cause the one or more processors to use the Boolean combination by incorporating one or more Boolean combinations into a user preference file for specifying preferences of combinations of attributes, the user preference file being configured for use in computing scores for one or more of the programs.

33. The system of claim 26, wherein the instructions cause the one or more processors to receive the Boolean combination via a network.

34. The system of claim 26, wherein the instructions cause the one or more processors to receive the Boolean combination via the Internet.

35. The system of claim 26, wherein the instructions cause the one or more processors to receive the Boolean combination via a third party.

36. A method comprising:
defining an electronically-exchangable file comprising one or more filter tokens, the filter tokens being configured to reduce an amount of information that is presented in an electronic program guide display; and
using the one or more filter tokens to reduce an amount of information that is provided to a user of an electronic program guide system embodying the display.

37. The method of claim 36, wherein the file comprises a hierarchically-tagged structure.

38. The method of claim 36, wherein the file comprises an XML file.

39. The method of claim 36 further comprising sending the file over a network.

40. The method of claim 36 further comprising sending the file over the Internet.

41. The method of claim 36 further comprising attaching the file as an email attachment.

42. A method comprising:
defining at least one electronically-exchangable Boolean combination of attributes associated with one or more programs that are subject to representation in an electronic program guide display; and
making the one Boolean combination of attributes electronically available different client devices that embody an electronic program guide system embodying the display to reduce an amount of information that is provided to one or more users of individual client devices.

43. The method of claim 42, wherein the Boolean combination can be used to reduce the amount of information that is displayed in an electronic program guide display.

44. The method of claim 42, wherein the Boolean combination can be used to reduce the amount of information that is used to make program recommendations to a user.

45. The method of claim 42, wherein the act of defining the Boolean combination comprises using a hierarchical file structure to define the combination.

46. The method of claim 42, wherein the act of defining the Boolean combination comprises using a hierarchical tag-based file structure to define the combination.

47. The method of claim 42, wherein the act of defining the Boolean combination comprises using an XML file to define the combination.

48. The method of claim 42, wherein the act of making the Boolean combination available is performed by making the combination available via a network.

49. The method of claim 42, wherein the act of making the Boolean combination available is performed by making the combination available via the Internet.

50. The method of claim 42 further comprising sending the Boolean combination to one or more users via a network.

51. The method of claim 42 further comprising sending the Boolean combination to one or more users via the Internet.

52. One or more computer-readable media embodying computer-readable instructions which, when executed by one or more processors, cause the one or more processors to implement the method of claim 42.

53. A system comprising:
one or more computer-readable media embodying computer-readable instructions which, when executed by one or more processors, cause the one or more processors to implement the method of claim 42; and
one or more computing devices embodying the one or more computer-readable media.

54. A system comprising:
at least one attribute and associated attribute value providing a first attribute-value pair, the attribute-value pair being associated with one or more programs that are subject to representation in an electronic program guide display;
at least one other attribute and associated attribute value providing a second attribute-value pair, the second attribute-value pair being associated with one or more programs that are subject to representation in an electronic program guide display;
at least one Boolean operator defining an association between the attribute-value pairs; and
the attribute-value pairs and associated Boolean operator being configured to be used to reduce an amount of information that is provided to a user of an electronic program guide system embodying the electronic program guide display.

55. The system of claim 54 embodied as a filter token having a hierarchical structure.

56. The system of claim 54 embodied as a filter token having a tag-based structure.

57. The system of claim 54 embodied as a filter token having a hierarchical, tag-based structure.

58. The system of claim 54, wherein the attributes comprise at least program attributes associated with individual programs.

59. The system of claim 54, wherein the attributes comprise at least instance attributes associated with individual instances of programs.

60. The system of claim 54, wherein the attributes comprise both program attributes associated with individual programs and instance attributes associated with individual instances of programs.

61. The system of claim 54, wherein the attribute-value pairs and associated Boolean operator are configured to be used to reduce the amount of information by including information to be provided to a user.

62. The system of claim 54, wherein the attribute-value pairs and associated Boolean operator are configured to be used to reduce the amount of information by excluding information to be provided to a user.

63. The system of claim 54, wherein the attribute-value pairs and associated Boolean operator are configured to be used to reduce the amount of information by both including and excluding information to be provided to a user.

64. One or more client devices embodying the system of claim 54.

65. One or more servers embodying the system of claim 54.

66. A system comprising:
one or more XML files, individual files comprising one or more tags for encapsulating attribute-value pairs that are to be used to reduce an amount of information that is provided to a user of an electronic program guide system embodying an electronic program guide display; and
at least one of the tags being associated with a Boolean operator.

67. The system of claim 66, wherein at least one of the tags comprises a tag that is operative to include information that is to be presented to a user.

68. The system of claim 66, wherein at least one of the tags comprises a tag that is operative to exclude information from presentation to a user.

69. The system of claim 66, wherein tags can further comprise a tag that is operative to include information that is to be presented to a user and a tag that is operative to exclude information from presentation to a user.

70. The system of claim 66, wherein said one tag comprises an OR tag.

71. The system of claim 66, wherein said one tag comprises an AND tag.

72. The system of claim 66, wherein said one tag comprises a NOT tag.

73. The system of claim 66, wherein said one tag comprises one or more of an OR tag, and AND tag, and a NOT tag.

74. One or more client devices embodying the system of claim 66 .

75. One or more servers embodying the system of claim 66.

76. A system comprising:
multiple electronically-exchangable filter tokens; and
individual filter tokens being configured for reducing an amount of information that is presented to a user of an electronic program guide system.

77. The system of claim 76, wherein the filter tokens comprise individual files.

78. The system of claim 76, wherein the filter tokens comprise individual XML files.

79. The system of claim 76, wherein at least one filter token comprises at least an exclusionary portion that excludes information from presentation to a user.

80. The system of claim 76, wherein at least one filter token comprises at least an inclusionary portion that includes information for presentation to a user.

81. The system of claim 76, wherein individual filter tokens can be cumulatively applied to cumulatively reduce information that is presented to a user.

82. The system of claim 76, wherein the filter tokens can specify program attributes associated with individual programs that can appear in or be removed from an electronic program guide display.

83. The system of claim 76, wherein the filter tokens can specify instance attributes associated with individual program instances that can appear in or be removed from an electronic program guide display.

84. The system of claim 76, wherein the filter tokens can specify both program attributes and instance attributes associated with individual programs that can appear in or be removed from an electronic program guide display.

85. The system of claim 76, wherein the filter tokens can be used to reduce information on a program-by-program basis.

86. A method comprising:
applying a first electronically-exchangable filter token to reduce an amount of information in an electronic program guide display; and
applying at least a second electronically-exchangable filter token to further reduce the amount of information in the electronic program guide display.

87. The method of claim 86, wherein said filter tokens can comprise inclusionary filter tokens that include information for display for the user, and exclusionary filter tokens that exclude information from display for the user.

88. The method of claim 86, wherein said filter tokens comprise individual files.

89. The method of claim 86, wherein said filter tokens comprise hierarchically-structured files.

90. The method of claim 86, wherein said filter tokens comprise individual tag-based files.

91. The method of claim 86, wherein said filter tokens comprise individual XML files.

92. The method of claim 86 further comprising electronically exchanging one or more filter tokens with a client device that is different from a client device on which the first and second filter tokens are applied.

93. One or more computer-readable media embodying computer-readable instructions which, when executed by one or more processors, cause the one or more processors to implement the method of claim 86.

94. A system comprising:
one or more processors;
one or more computer-readable media embodying computer-readable instructions which, when executed by the one or more processors, cause the one or more processors to:
apply a first electronically-exchangable filter token to reduce an is amount of information in an electronic program guide display; and
apply at least a second electronically-exchangable filter token to further reduce the amount of information in the electronic program guide display;
at least one filter token being capable of being configured to reduce information on a program-by-program basis.

95. The system of claim 94, wherein said filter tokens can comprise inclusionary filter tokens that include information for display for the user, and exclusionary filter tokens that exclude information from display for the user.

96. The system of claim 94, wherein said filter tokens comprise individual files.

97. The system of claim 94, wherein said filter tokens comprise hierarchically-structured files.

98. The system of claim 94, wherein said filter tokens comprise individual tag-based files.

99. The system of claim 94, wherein said filter tokens comprise individual XML files.

100. A method comprising:
receiving one or more filter tokens, individual filter tokens being configured to reduce an amount of information in an electronic program guide display; and
allocating filter tokens to function buttons associated with an electronic program guide system, at least one filter token being capable of being configured to reduce information on a program-by-program basis.

101. The method of claim 100 further comprising displaying the function buttons for selection by a user.

102. The method of claim 100 further comprising:
displaying the function buttons for selection by a user;
receiving user input via one or more function buttons; and
applying an associated filter token to reduce the information in the electronic program guide display.

103. The method of claim 100, wherein at least one filter token is received from a cache on a client device embodying an electronic program guide.

104. The method of claim 100, wherein at least one filter token is received via a network.

105. The method of claim 100, wherein at least one filter token is received via the Internet.

106. One or more computer-readable media embodying computer-readable instructions which, when executed by one or more processors, cause the one or more processors to implement the method of claim 100.

107. A system comprising:
one or more computer-readable media embodying computer-readable instructions which, when executed by one or more processors, cause the one or more processors to implement the method of claim 100; and
one or more client devices embodying the one or more computer-readable media.

108. A method comprising:
applying one or more electronically-exchangable filter tokens, individual filter tokens being configured to reduce an amount of information in an electronic program guide display, at least one filter token being capable of being configured to reduce information on a program-by-program basis;
ascertaining whether an electronic program guide display can be reduced in size as a result of applying the one or more filter tokens; and
if the electronic program guide display can be reduced in size, then reducing the size of the electronic program guide display.

109. The method of claim 108, wherein filter tokens comprise individual files.

110. The method of claim 108, wherein filter tokens comprise individual XML files.

111. The method of claim 108, wherein at least one filter token comprises at least an exclusionary portion that excludes information from presentation to a user.

112. The method of claim 108, wherein at least one filter token comprises at least an inclusionary portion that includes information for presentation to a user.

113. The method of claim 108, wherein individual filter tokens can be cumulatively applied to cumulatively reduce information that is presented to a user.

114. The method of claim 108, wherein filter tokens specify program attributes associated with individual programs that can appear in or be removed from an electronic program guide display.

115. The method of claim 108, wherein filter tokens specify instance attributes associated with individual program instances that can appear in or be removed from an electronic program guide display.

116. The method of claim 108, wherein filter tokens specify both program attributes and instance attributes associated with individual programs that can appear in or be removed from an electronic program guide display.

117. One or more computer-readable media embodying computer-readable instructions which, when executed by one or more processors, cause the one or more processors to implement the method of claim 108.

118. A system comprising:
one or more computer-readable media embodying computer-readable instructions which, when executed by one or more processors, cause the one or more processors to implement the method of claim 108; and
one or more client devices embodying the one or more computer-readable.

119. A method comprising:
defining a filter token that comprises a Boolean combination of attributes to be used to reduce an amount of information that is provided to a user of an electronic program guide system embodying a display;
associating with said Boolean combination a preference value which reflects a user's preference for the Boolean combination; and
the preference value being configured for use in computing a score for programs that match the Boolean combination.

120. The method of claim 119, wherein said acts of defining and associating produce at least a portion of an XML file.

121. The method of claim 119 further comprising associating the Boolean combination and associated preference value with a user preference file associated with the user.

122. The method of claim 119, wherein said acts of defining and associating are performed at least in part using a user interface that is presented to the user.

123. The method of claim 119, wherein said acts of defining and associating are performed at least in part by analyzing a viewing log associated with the user.

124. One or more computer-readable media embodying computer-readable instructions which, when executed by one or more processors, cause the one or more processors to implement the method of claim 119.

125. A system comprising:
one or more computer-readable media embodying computer-readable instructions which, when executed by one or more processors, cause the one or more processors to implement the method of claim 119; and
one or more client devices embodying the one or more computer-readable media.

126. A method comprising:
defining a filter token that comprises a Boolean combination of attributes to be used to reduce an amount of information that is provided to a user of an electronic program guide system embodying a display;
associating with said Boolean combination a preference value which reflects a user's preference for the Boolean combination; and
the preference value being configured for use in computing a score for programs that match the Boolean combination.

127. The method of claim 126, wherein said acts of defining and associating produce at least a portion of an XML file.

128. The method of claim 126 further comprising associating the Boolean combination and associated preference value with a user preference file associated with the user.

129. The method of claim 126, wherein said acts of defining and associating are performed at least in part using a user interface that is presented to the user.

130. The method of claim 126, wherein said acts of defining and associating are performed at least in part by analyzing a viewing log associated with the user.

131. One or more computer-readable media embodying computer-readable instructions which, when executed by one or more processors, cause the one or more processors to implement the method of claim 126.

132. A system comprising:
one or more computer-readable media embodying computer-readable instructions which, when executed by one or more processors, cause the one or more processors to implement the method of claim 126; and
one or more client devices embodying the one or more computer-readable media.
